(19) United States
(12) Patent Application Publication
(10) Pub. No.: US 2021/0159692 A1
(43) Pub. Date: May 27, 2021

(54) LINE CAPACITANCE DISCHARGE IN A POWER DISTRIBUTION SYSTEM EMPLOYING SAFETY POWER DISCONNECTION

(71) Applicant: Corning Research & Development Corporation, Corning, NY (US)

(72) Inventor: Ami Hazani, Raanana (IL)

(21) Appl. No.: 17/104,892

(22) Filed: Nov. 25, 2020

Related U.S. Application Data
(60) Provisional application No. 62/941,156, filed on Nov. 27, 2019.

(51) Int. Cl. H02H 7/22; H02J 3/38; H02H 1/00

(52) U.S. Cl. CPC H02H 7/222; H02H 1/0007; H02J 3/38

(57) ABSTRACT

Line capacitance discharge in a power distribution system employing safety power disconnection is disclosed. The power distribution system is configured to remotely distribute power from a power source over current carrying electrical conductors (“power conductors”) to remote units to provide power-to-power consuming components of the remote units for operation. The power distribution system is configured to detect an unsafe condition, such as a touching or causing of a short circuit on the power conductors by a human. A line discharge circuit is provided in the power distribution system that is coupled to the power conductors and the controller circuit. The line discharge circuit is configured to be controlled to discharge charge from the power conductors in response to disconnection of the remote unit(s) from the power conductors.

### CROSS-REFERENCE TO RELATED APPLICATIONS

The present application claims priority to U.S. Provisional Patent Application No. 62/941,156, filed Nov. 27, 2019, and entitled “LINE CAPACITANCE DISCHARGE IN A POWER DISTRIBUTION SYSTEM EMPLOYING SAFETY POWER DISCONNECTION,” the contents of which is incorporated herein by reference in its entirety.

### BACKGROUND

The disclosure relates generally to distribution of power to one or more power consuming devices over power wiring, and more particularly to line capacitance discharge after safety power disconnection in a power distribution system that remotely distributes power to remote units, which may include distributed communications systems (DCSs) such as distributed antenna systems (DASs) or a small cell radio access network (RAN) as examples.

Wireless customers are increasingly demanding wireless communications services, such as cellular communications services and Wi-Fi services. Thus, small cells, and more recently Wi-Fi services, are being deployed indoors. At the same time, some wireless customers use their wireless communications devices in areas that are poorly serviced by conventional cellular networks, such as inside certain buildings or areas where there is little cellular coverage. One response to the intersection of these two concerns has been the use of DASs. DASs include remote antenna units (RAUs) configured to receive and transmit communications signals to client devices within the antenna range of the RAUs. DASs can be particularly useful when deployed inside buildings or other indoor environments where the wireless communications devices may not otherwise be able to effectively receive radio frequency (RF) signals from a source.

In this regard, FIG. 1 illustrates a wireless distributed communications system (WDCS) 100 that is configured to distribute communications services to remote coverage areas 102(1)-102(N), where ‘N’ is the number of remote coverage areas. The WDCS 100 in FIG. 1 is provided in the form of a DAS 104. The DAS 104 can be configured to support a variety of communications services that can include cellular communications services, wireless communications services, such as RF identification (RFID) tracking, Wireless Fidelity (Wi-Fi), local area network (LAN), and wireless LAN (WLAN), wireless solutions (Bluetooth, Wi-Fi Global Positioning System (GPS) signal-based, and others) for location-based services, and combinations thereof, as examples. The remote coverage areas 102(1)-102(N) are created by and centered on remote units 106(1)-106(N) connected to a central unit 108 (e.g., a head-end controller, a central unit, or a head-end unit). The central unit 108 may be communicatively coupled to a source transceiver 110, such as for example, a base transceiver station (BTS) or a baseband unit (BBU). In this regard, the central unit 108 receives downlink communications signals 112D from the source transceiver 110 to be distributed to the remote units 106(1)-106(N). The downlink communications signals 112D can include data communications signals and/or communication signaling signals, as examples. The central unit 108 is configured with filtering circuits and/or other signal processing circuits that are configured to support a specific number of communications services in a particular frequency bandwidth (i.e., frequency communications bands). The downlink communications signals 112D are communicated by the central unit 108 over a communications link 114 over their frequency to the remote units 106(1)-106(N).

With continuing reference to FIG. 1, the remote units 106(1)-106(N) are configured to receive the downlink communications signals 112D from the central unit 108 over the communications link 114. The downlink communications signals 112D are configured to be distributed to the respective remote coverage areas 102(1)-102(N) of the remote units 106(1)-106(N). The remote units 106(1)-106(N) are also configured with filters and other signal processing circuits that are configured to support all or a subset of the specific communications services (i.e., frequency communications bands) supported by the central unit 108. In a non-limiting example, the communications link 114 may be a wired communications link, a wireless communications link, or an optical fiber-based communications link. Each of the remote units 106(1)-106(N) may include an RF transmitter/receiver 116(1)-116(N) and a respective antenna 118(1)-118(N) operably connected to the RF transmitter/receiver 116(1)-116(N) to wirelessly distribute the communications services to user equipment (UE) 120 within the respective remote coverage areas 102(1)-102(N). The remote units 106(1)-106(N) are also configured to receive uplink communications signals 112U from the UE 120 in the respective remote coverage areas 102(1)-102(N) to be distributed to the source transceiver 110.

Because the remote units 106(1)-106(N) include components that require power to operate, such as the RF transmitter/receivers 116(1)-116(N) for example, it is necessary to provide power to the remote units 106(1)-106(N). In one example, each remote unit 106(1)-106(N) may receive power from a local power source. In another example, the remote units 106(1)-106(N) may be powered remotely from a remote power source(s). For example, the central unit 108 may include a power source 122 that is configured to remotely supply power over the communications links 114 to the remote units 106(1)-106(N). For example, the communications links 114 may be cables that include electrical conductors for carrying current (e.g., direct current (DC)) to the remote units 106(1)-106(N). If the WDCS 100 is an optical fiber-based WDCS in which the communications links 114 include optical fibers, the communications links 114 may be a “hybrid” cable that includes optical fibers for carrying the downlink and uplink communications signals 112D, 112U and separate electrical conductors for carrying current to the remote units 106(1)-106(N).

Some regulations, such as IEC 60950-21, may limit the amount of direct current (DC) that is remote delivered by the power source 122 over the communications links 114 to less than the amount needed to power the remote units 106(1)-106(N) during peak power consumption periods for safety reasons, such as in the event a human contacts the wire. One solution to remote power distribution limitations is to employ multiple conductors and split current from the power source 122 over the multiple conductors, such that the current on any one electrical conductor is below the regulated limit. Another solution includes delivering remote power at a higher voltage so that a lower current can be distributed at the same power level. For example, assume that 300 Watts of power is to be supplied to a remote unit 106(1)-106(N) by the power source 122 through a communications link 114. If the voltage of the power source 122 is 60 Volts (V), the current will be 5 Amperes (A) (i.e., 300 W/60 V). However, if a 400 Volt power source 122 is used, then the current flowing through the wires will be 0.75 A. However, delivering high voltage through electrical conductors may be further regulated to prevent an undesired current from flowing through a human in the event that a human contacts the electrical conductor. Thus, these safety measures may require other protections, such as the use of protection conduits, which may make installations more difficult and add cost.

No admission is made that any reference cited herein constitutes prior art. Applicant expressly reserves the right to challenge the accuracy and pertinency of any cited documents.

### SUMMARY

Embodiments of the disclosure relate to line capacitance discharge in a power distribution system employing safety power disconnection. The power distribution system is configured to remotely distribute power from a power source over current carrying electrical conductors (“power conductors”) to remote units to provide power-to-power consuming components of the remote units for operation. As a non-limiting example, such power distribution may be provided in a distributed communications system (DCS), such as a distributed antenna system (DAS) or radio cell network. The power distribution system is configured to detect an unsafe condition, such as a touching or causing of a short circuit on the power conductors by a human. In this regard, in one example, a remote unit(s) in the power distribution system is configured to periodically decouple its power consuming components from the power conductors thereby disconnecting the load of the remote unit(s) from the power source in the power distribution system. The remote units are configured to be able to continue to operate during this decoupling interruption, such as by discharge of power from a capacitor circuit that is charged when coupled to the power conductors. A current measurement circuit provided in the power distribution system is configured to measure current delivered by the power source over the power conductors to the remote units when the remote unit load is periodically disconnected from the power conductors. Current should not be flowing on the power conductors when the remote unit(s) is decoupled and an open circuit exists on the power conductors. The controller circuit is configured to disconnect the power source from the power conductors for safety reasons in response to the current measurement circuit measuring a current in excess of a threshold current level from the power source since current should not be flowing. For example, a person contacting the power conductors will present a load to the power source that can cause a current to flow from the power source over the power conductors. If another load is not contacting the power conductors, no current (or only a small amount of current due to current leakages for example) should flow from the power source over the power conductors.

In additional exemplary aspects disclosed herein, a line discharge circuit is provided in the power distribution system that is coupled to the power conductors and the controller circuit. The line discharge circuit is configured to be controlled to discharge charge from the power conductors in response to disconnection of the remote unit(s) from the power conductors. When current is flowing from the power source on the power conductors to coupled remote units during normal operation, residual energy in the form of charge can be built up on the power conductors due to their parasitic capacitance. The capacitance in electrical components in the power source and remote units coupled to the power conductors can also contribute towards this parasitic capacitance. When a remote unit(s) in the power distribution system periodically disconnects its power consuming components from the power conductors to allow the controller circuit to detect if an unsafe condition exists on the power conductors, the built up charge on the power conductors is present. It takes time for the residual charge on the power conductors to discharge after the remote unit(s) is decoupled from the power conductors. This residual charge on the power conductors can expose a person to a voltage charge longer than desired if a person is touching the power conductors in an unsafe manner. Also, if the power source is configured to regulate the off voltage time on the power conductors during disconnect times to, in effect, provide signaling or management communications to the remote unit(s), such as for synchronization of remote unit disconnect and connect times for example, the residual charge on the power conductors can delay these communications. The time it takes for residual charge on the power conductors to be discharged may need to be accounted for before voltage signaling can be performed to provide communications. Thus, by actively discharging the power conductor lines during remote unit disconnect times, a person may be exposed less time to charge on the power conductors and/or communication signaling may be able to be performed faster. Being able to perform communication signaling faster over the power conductors may also allow the overall disconnection times to be reduced for more effective power transfer.

In this regard, in one exemplary aspect, a power distribution system is provided. The power distribution system comprises one or more power distribution circuits each comprising a distribution power input configured to receive current distributed by a power source, a distribution power output configured to distribute the received current over a power conductor coupled to an assigned remote unit among a plurality of remote units, and a distribution switch circuit coupled between the distribution power input and the distribution power output. The distribution switch circuit comprises a distribution switch control input configured to receive a distribution power connection control signal indicating a distribution power connection mode. The distribution switch circuit is configured to be closed to couple the distribution power input to the distribution power output in response to the distribution power connection mode indicating a distribution power connect state, and to be opened to decouple the distribution power input from the distribution power output in response to the distribution power connection mode indicating a distribution power disconnect state. The one or more power distribution circuits each further comprise a current measurement circuit coupled to the distribution power output and comprising a current measurement output. The current measurement circuit is configured to measure a current at the distribution power output and generate a current measurement on the current measurement output based on the measured current at the distribution power output. The one or more power distribution circuits each further comprise a line discharge circuit comprising a line discharge switch coupled to the power conductor and configured to receive a line discharge signal. The line discharge switch is configured to be closed in response to the line discharge signal indicating a closed state, and the line discharge switch is configured to be opened in response to the line discharge signal indicating an open state. The power distribution system further comprises a controller circuit comprising one or more current measurement inputs communicatively coupled to the one or more current measurement outputs of the one or more current measurement circuits of the one or more power distribution circuits. The controller circuit is configured to, for a power distribution circuit among the one or more power distribution circuits, generate the distribution power connection control signal indicating the distribution power connection mode to the distribution switch control input of the power distribution circuit indicating the distribution power connect state. The controller circuit is further configured to, for a power distribution circuit among the one or more power distribution circuits, determine if the measured current on a current measurement input among the one or more current measurement inputs of the power distribution circuit exceeds a predefined threshold current level when the distribution switch circuit is closed to couple the distribution power input to the distribution power output. In response to the measured current of the power distribution circuit exceeding the predefined threshold current level, the controller circuit is configured to communicate the distribution power connection control signal indicating the distribution power connection mode to the distribution switch control input of the power distribution circuit indicating the distribution power disconnect state, and communicate the line discharge signal in the closed state to cause the line discharge switch to be closed to discharge the power conductor.

An additional aspect of the disclosure relates to a method of disconnecting current from a power source. The method comprises decoupling current from a power conductor to a remote unit, measuring a current received from a power source coupled to the power conductor, and determining if the measured current exceeds a predefined threshold current level. In response to the measured current exceeding the predefined threshold current level, method further comprises communicating a distribution power connection control signal comprising a distribution power connection mode indicating a distribution power disconnect state to cause the power conductor to be decoupled from the power source, and communicating a line discharge signal in a closed state to cause a line discharge switch coupled to the power conductor to be closed to discharge the power conductor through the line discharge switch.

An additional aspect of the disclosure relates to a DCS comprising a central unit configured to distribute received one or more downlink communications signals over one or more downlink communications links to one or more remote units, and distribute received one or more uplink communications signals from the one or more remote units from one or more uplink communications links to one or more source communications outputs. The DCS also comprises a plurality of remote units, each remote unit among the plurality of remote units comprising a remote power input coupled to a power conductor carrying current from a power distribution circuit, a remote switch control circuit configured to generate a remote power connection signal indicating a remote power connection mode, and a remote switch circuit comprising a remote switch input configured to receive the remote power connection signal. The remote switch circuit is configured to be closed to couple to the remote power input in response to the remote power connection mode indicating a remote power connect state. The remote switch circuit is further configured to be opened to decouple from the remote power input in response to the remote power connection mode indicating a remote power disconnect state. The remote unit is configured to distribute the received one or more downlink communications signals received from the one or more downlink communications links, to one or more client devices, and distribute the received one or more uplink communications signals from the one or more client devices to the one or more uplink communications links. The DCS also comprises a power distribution system. The power distribution system comprises one or more power distribution circuits each comprising a distribution power input configured to receive current distributed by a power source, a distribution power output configured to distribute the received current over a power conductor coupled to an assigned remote unit among the plurality of remote units, and a distribution switch circuit coupled between the distribution power input and the distribution power output, the distribution switch circuit comprising a distribution switch control input configured to receive a distribution power connection control signal indicating a distribution power connection mode. The distribution switch circuit is configured to be closed to couple the distribution power input to the distribution power output in response to the distribution power connection mode indicating a distribution power connect state. The distribution switch circuit is further configured to be opened to decouple the distribution power input from the distribution power output in response to the distribution power connection mode indicating a distribution power disconnect state. Each of the one or more power distribution circuits also comprises a current measurement circuit coupled to the distribution power output and comprising a current measurement output. The current measurement circuit is configured to measure a current at the distribution power output and generate a current measurement on the current measurement output based on the measured current at the distribution power output. Each of the one or more power distribution circuits also comprises a line discharge circuit comprising a line discharge switch coupled to the power conductor and configured to receive a line discharge signal, the line discharge switch configured to be closed in response to a line discharge signal indicating a closed state and the line discharge switch configured to be opened in response to the line discharge signal indicating an open state. The power distribution system also comprises a controller circuit comprising one or more current measurement inputs communicatively coupled to the one or more current measurement outputs of the one or more current measurement circuits of the one or more power distribution circuits. The controller circuit is configured to, for a power distribution circuit among the one or more power distribution circuits, generate the distribution power connection control signal indicating the distribution power connection mode to the distribution switch control input of the power distribution circuit indicating the distribution power connect state. The controller circuit is further configured to, for a power distribution circuit among the one or more power distribution circuits, determine if the measured current on a current measurement input among the one or more current measurement inputs of the power distribution circuit exceeds a predefined threshold current level. In response to the measured current of the power distribution circuit exceeding the predefined threshold current level, controller circuit is further configured to communicate the distribution power connection control signal comprising the distribution power connection mode to the distribution switch control input of the power distribution circuit indicating the distribution power disconnect state, and communicate the line discharge signal in the closed state to cause the line discharge switch to be closed to discharge the power conductor.

Additional features and advantages will be set forth in the detailed description which follows and, in part, will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

The accompanying drawings are included to provide a further understanding of the disclosure, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary wireless distributed communications system (WDCS) in the form of a distributed antenna system (DAS);

FIG. 2 is a schematic diagram illustrating an exemplary power distribution system that can be included in a DCS, wherein the power distribution system is configured to provide safety power disconnect of the power source to a remote unit in response to a measured current from the connected power source when the remote unit is decoupled from the power source;

FIG. 3 is a timing diagram illustrating an exemplary timing sequence of the controller circuit in the power distribution system in FIG. 2;

FIGS. 4A and 4B are schematic diagrams illustrating the exemplary power distribution system in FIG. 2 that can be included in a DCS, wherein the power distribution system is configured to perform a line capacitance discharge of power conductors between a power source and a remote unit(s) when a safety disconnect of the power source is performed in response to a measured current from the connected power source when the remote unit is decoupled from the power source;

FIG. 5 is a timing diagram illustrating an exemplary timing sequence of the controller circuit in the power distribution system in FIGS. 4A and 4B;

FIG. 6 is a flowchart illustrating an exemplary process of the controller circuit in the power distribution system in FIGS. 4A and 4B performing a line capacitance discharge of power conductors in response to a remote unit(s) decoupling from the power source in a testing phase and the power source performing a safety disconnect;

FIG. 7 is a schematic diagram of an exemplary optical-fiber based DCS configured to distribute communications signals between a central unit and a plurality of remote units, and that can include one or more power distribution systems, including the power distribution systems in FIGS. 4A-4B configured to perform a line capacitance discharge of power conductors between a power source and a remote unit(s) when a safety disconnect of the power source is performed in response to a measured current from the connected power source when the remote unit is decoupled from the power source;

FIG. 8 is a partially schematic cut-away diagram of an exemplary building infrastructure in which the DCS in FIG. 7 can be provided;

FIG. 9 is a schematic diagram of an exemplary mobile telecommunications environment that includes an exemplary radio access network (RAN) that includes a mobile network operator (MNO) macrocell employing a radio node, a shared spectrum cell employing a radio node, an exemplary small cell RAN employing a multi-operator radio node located within an enterprise environment as DCSs, and that can include one or more power distribution systems, including the power distribution systems in FIGS. 4A-4B, 7, and 8, configured to perform a line capacitance discharge of power conductors between a power source and a remote unit(s) when a safety disconnect of the power source is performed in response to a measured current from the connected power source when the remote unit is decoupled from the power source;

FIG. 10 is a schematic diagram an exemplary DCS that supports 4G and 5G communications services, and that can include one or more power distribution systems, including the power distribution systems in FIGS. 4A-4B and 7-9, configured to perform a line capacitance discharge of power conductors between a power source and a remote unit(s) when a safety disconnect of the power source is performed in response to a measured current from the connected power source when the remote unit is decoupled from the power source; and

FIG. 11 is a schematic diagram of a generalized representation of an exemplary controller that can be included in any component or circuit in a power distribution system, including the power distribution systems in FIGS. 4A-4B and 7-10, that is configured to perform a line capacitance discharge of power conductors between a power source and a remote unit(s) when a safety disconnect of the power source is performed in response to a measured current from the connected power source when the remote unit is decoupled from the power source, wherein an exemplary computer system is adapted to execute instructions from an exemplary computer readable link.

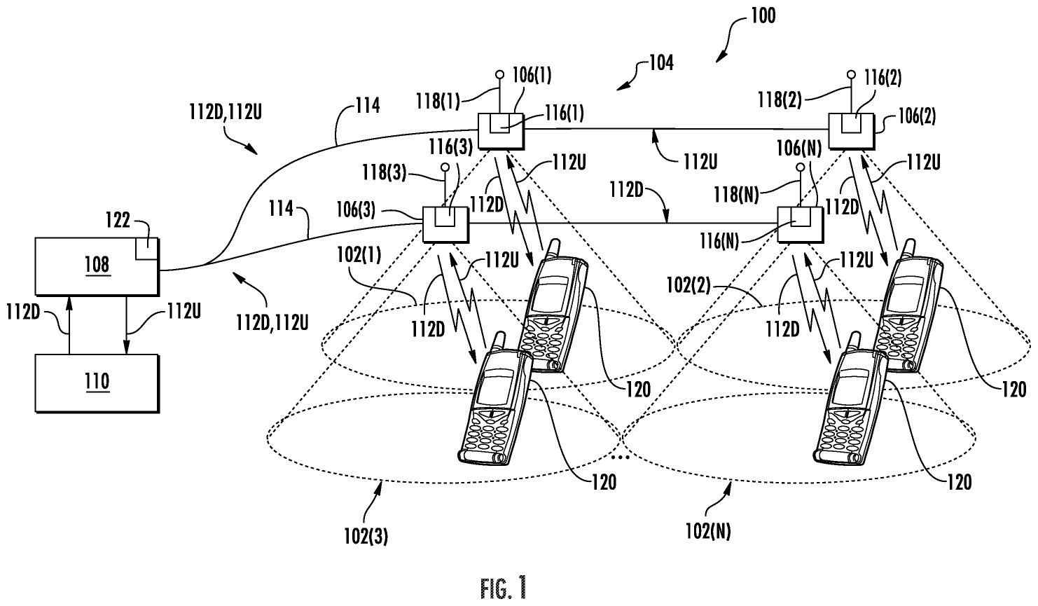

### DETAILED DESCRIPTION

Embodiments of the disclosure relate to line capacitance discharge in a power distribution system employing safety power disconnection. The power distribution system is configured to remotely distribute power from a power source over current carrying electrical conductors (“power conductors”) to remote units to provide power-to-power consuming components of the remote units for operation. As a non-limiting example, such power distribution may be provided in a distributed communications system (DCS), such as a distributed antenna system (DAS) or radio cell network. The power distribution system is configured to detect an unsafe condition, such as a touching or causing of a short circuit on the power conductors by a human. In this regard, in one example, a remote unit(s) in the power distribution system is configured to periodically decouple its power consuming components from the power conductors thereby disconnecting the load of the remote unit(s) from the power source in the power distribution system. The remote units are configured to be able to continue to operate during this decoupling interruption, such as by discharge of power from a capacitor circuit that is charged when coupled to the power conductors. A current measurement circuit provided in the power distribution system is configured to measure current delivered by the power source over the power conductors to the remote units when the remote unit load is periodically disconnected from the power conductors. Current should not be flowing on the power conductors when the remote unit(s) is decoupled and an open circuit exists on the power conductors. The controller circuit is configured to disconnect the power source from the power conductors for safety reasons in response to the current measurement circuit measuring a current in excess of a threshold current level from the power source since current should not be flowing. For example, a person contacting the power conductors will present a load to the power source that can cause a current to flow from the power source over the power conductors. If another load is not contacting the power conductors, no current (or only a small amount of current due to current leakages for example) should flow from the power source over the power conductors.

In additional exemplary aspects disclosed herein, a line discharge circuit is provided in the power distribution system that is coupled to the power conductors and the controller circuit. The line discharge circuit is configured to be controlled to discharge charge from the power conductors in response to disconnection of the remote unit(s) from the power conductors. When current is flowing from the power source on the power conductors to coupled remote units during normal operation, residual energy in the form of charge can be built up on the power conductors due to their parasitic capacitance. The capacitance in electrical components in the power source and remote units coupled to the power conductors can also contribute towards this parasitic capacitance. When a remote unit(s) in the power distribution system periodically disconnects its power consuming components from the power conductors to allow the controller circuit to detect if an unsafe condition exists on the power conductors, the built up charge on the power conductors is present. It takes time for the residual charge on the power conductors to discharge after the remote unit(s) is decoupled from the power conductors. This residual charge on the power conductors can expose a person to a voltage charge longer than desired if a person is touching the power conductors in an unsafe manner. Also, if the power source is configured to regulate the off voltage time on the power conductors during disconnect times to, in effect, provide signaling or management communications to the remote unit(s), such as for synchronization of remote unit disconnect and connect times for example, the residual charge on the power conductors can delay these communications. The time it takes for residual charge on the power conductors to be discharged may need to be accounted for before voltage signaling can be performed to provide communications. Thus, by actively discharging the power conductor lines during remote unit disconnect times, a person may be exposed less time to charge on the power conductors and/or communication signaling may be able to be performed faster. Being able to perform communication signaling faster over the power conductors may also allow the overall disconnection times to be reduced for more effective power transfer.

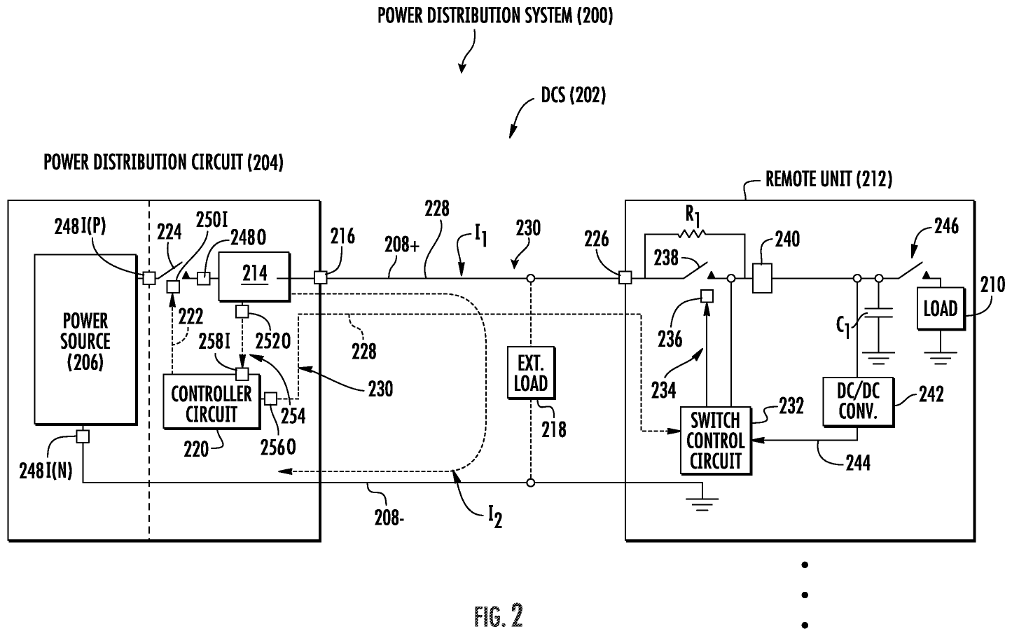

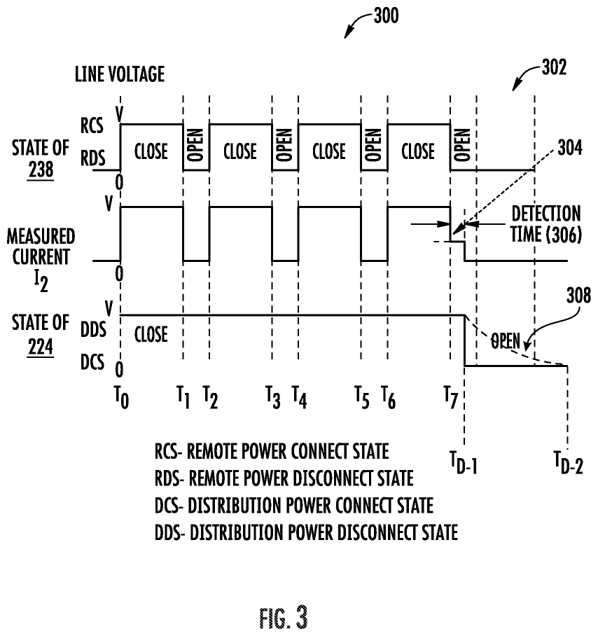

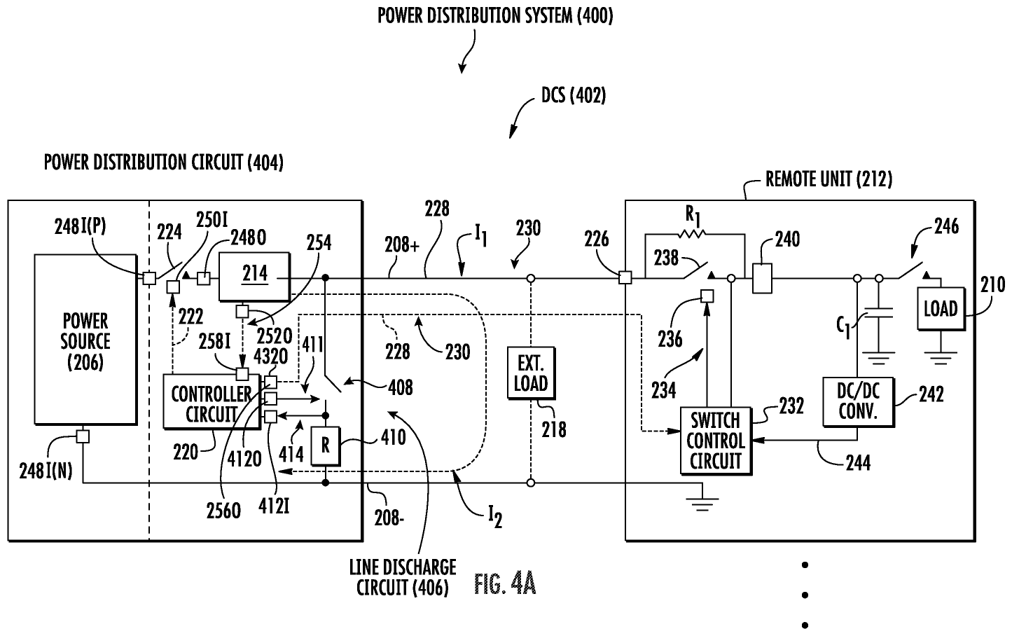

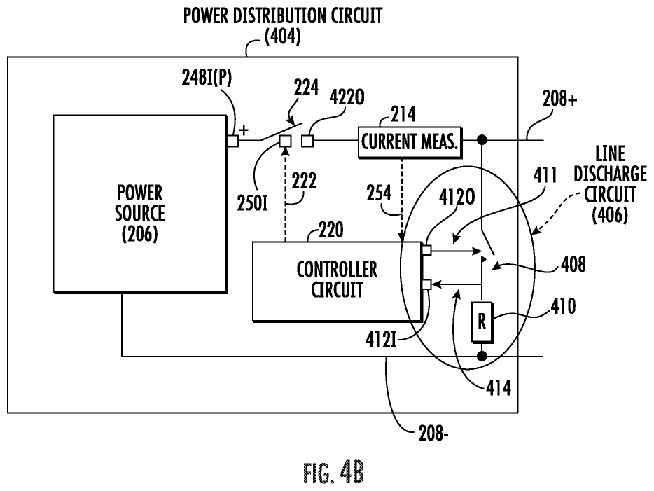

Before discussing exemplary details of a power distribution system that can be included in a DCS, wherein the power distribution system is configured to perform a line capacitance discharge of power conductors between a power source and a remote unit(s) when a safety disconnect of the power source is performed in response to a measured current from the connected power source when the remote unit is decoupled from the power source starting at FIG. 4A, an exemplary power distribution system that does not include line capacitance discharge is discussed first with regards to FIGS. 2 and 3.

FIG. 2 illustrates a power distribution system 200 that is provided in a DCS 202. The DCS 202 can be a distributed antenna system (DAS) or small cell radio access network (RAN) as examples. The power distribution system 200 includes a power distribution circuit 204 that includes a power source 206 configured to supply power (i.e., current I₁) to be distributed over power conductors 208+, 208− to a load 210 of a remote unit 212 to provide power to the remote unit 212 for operation of its consuming components. For example, the power distribution circuit 204 may be included in a head-end unit of a DCS that is configured to distribute communications signals to one or more of the remote units 212. Only one remote unit 212 is shown, but the power distribution circuit 204 may be interfaced to a plurality of the remote units 212. The remote units 212 may be radio antenna units that are configured to receive and radiate communications signals wirelessly through an antenna as an example. The remote units 212 could also be radio units that are configured to receive signals that are processed and modulated into radio signals to be wirelessly transmitted through an antenna. The remote units 212 included power consuming components that require power to operate. The power distribution circuit 204 is configured to supply power from the power source 206 over the power conductors 208+, 208− to the remote unit 212 to be powered.

As an example, the power source 206 may be a DC/DC power supply (e.g., 48V DC/350V DC) or AC/DC power supply (e.g., AC/350 V DC). The power source 206 may be included in the same housing or chassis as the power distribution circuit 204, or separate from the power distribution circuit 204. The power distribution circuit 204 illustrated in FIG. 2 is configured to provide safety power disconnect of the power source 206 from the power conductors 208+, 208− in response to a measured current I₂ from the connected power source 206 when the remote unit 212 is decoupled from the power source 206 in a testing phase. The power distribution circuit 204 includes a current measurement circuit 214 that is configured to measure the current I₂ delivered by the power source 206 to a distribution power output 216 coupled to the power conductors 208+, 208− as an indication of a safety condition as to whether an external load 218, such as a human, is in contact on the power conductors 208+, 208−. If another load is not contacting the power conductors 208+, 208−, this means no current or only a small amount of current, due to current leakages for example, should flow from the power source 206 to the power conductors 208+, 208−. However, if an external load 218, such as a person, is contacting the power conductors 208+, 208−, this load 218 will present a load to the power source 206 that will cause the current I₂ to flow from the power source 206 over the power conductors 208+, 208−. This current I₂ can be detected as a method of detecting an external load 218, such as a human, in contact with the power conductors 208+, 208− to cause the power distribution circuit 204 to decouple the power source 206 from the power conductors 208+, 208− as a safety measure.

In this regard, with reference to FIG. 2, the power distribution circuit 204 includes a controller circuit 220. The controller circuit 220 is configured to send a distribution power connection control signal 222 indicating a distribution power connection state to close a distribution switch circuit 224 to couple the power source 206 to the current measurement circuit 214. The closing of the distribution switch circuit 224 allows current I₁ to be drawn from the power source 206 and be carried by the power conductor 208+ to a remote power input 226 of the remote unit 212. To determine if an external load 218 other than the remote circuit 212, such as a human, is contacting the power conductors 208+, 208−, the controller circuit 220 could be configured to communicate over a management communications link 228 to the remote unit 212. The management communications link 228 may be electrical conductors (e.g., copper wire) or optical fiber medium as examples. The management communications link 228 may be a bidirectional communications link configured to carry a full duplex signal at a carrier frequency, such as 1.5 MHz for example. The controller circuit 220 can be configured to send a remote power connection signal 230 indicating a remote power disconnect state to a switch control circuit 232 coupled to the management communications link 228. Alternatively, the controller circuit 220 could be configured to communicate over the remote power connection signal 230 to the remote unit 212 over the power conductors 208+ as discussed in more detail below.

In response, the switch control circuit 232 is configured to send a remote power connection signal 234 indicating the remote power disconnect state to a remote switch input 236 to open a remote switch circuit 238 in the remote unit 212 to decouple the remote unit 212 from power conductor 208+ thereby disconnecting the load of the remote unit 212 from the power distribution circuit 204. This allows a measurement current on the power conductors 208+, 208− to be associated with an external load 218 and not the load of the remote unit 212. When the remote switch circuit 238 is open, power is provided to the load 210 from a capacitor C₁. The current measurement circuit 214 measures the current on the power conductors 208+, 208− while the remote unit 212 is decoupled from the power source 206. If an external load 218 is not contacting the power conductors 208+, 208−, this means no current (or only a small amount of current due to current leakages for example) should flow from the power source 206 to the power conductors 208+, 208−. However, if an external load 218, such as a person, is contacting the power conductors 208+, 208−, this load will present a load to the power source 206 that can cause current I₂ to flow from the power source 206 over the power conductors 208+, 208−. Any measured current I₂ by the current measurement circuit 214 is communicated to the controller circuit 220. In response to detection of the external load 218 as a function of the measured current I₂ exceeding a predefined threshold current level, the controller circuit 220 is configured to communicate the distribution power connection control signal 222 indicating a distribution power disconnect state to the distribution switch circuit 224 to disconnect the power source 206 from the power conductors 208+, 208− for safety reasons. This is because the external load 218 applied to the power conductors 208+, 208− to cause the current I₂ to flow from the power source 206 may be a human contacting the power conductors 208+, 208−.

Note that the management communications link 228 can be a separate communications link from the power conductors 208+, 208− or a modulated signal (e.g., a pulse width modulated (PWM) signal) coupled to the power conductors 208+, 208− such that the remote power connection signal 230 is communicated over the power conductors 208+, 208−. If the management communications link 228 is provided as a separate communications link, the management communications link 228 may be electrical conducting wire, such as copper wires for example. The management communications link 228 could also carry power to the switch control circuit 232 to power the switch control circuit 232 since the management communications link 228 is coupled to the switch control circuit 232. For example, the predefined current threshold level may be based on the voltage of the power source 206 and an estimated 2,000 Ohms resistance of a human. For example, the International Electric Code (IEC) 60950-21 entitled “Remote Powering Regulatory Requirements” provides that for a 400 VDC maximum line-to-line voltage, the human body resistance from hand to hand is assumed to be 2,000 Ohms resulting in a body current of 200 mA. The remote unit 212 is eventually recoupled to the power source 206 to once again be operational.

After the controller circuit 220 communicates the distribution power connection control signal 222 indicating the distribution power disconnect state to the distribution switch circuit 224 to disconnect the power source 206 from the power conductors 208+, 208−, the controller circuit 220 can be configured to wait a period of time and/or until a manual reset instruction is received before recoupling the power source 206 to the remote unit 212. In this regard, the controller circuit 220 can communicate the distribution power connection control signal 222 indicating a distribution power connect state to the distribution switch circuit 224 to cause the distribution switch circuit 224 to be closed to couple the power source 206 to the power conductors 208+, 208−. The controller circuit 220 can also send the remote power connection signal 230 indicating a remote power connect state to the switch control circuit 232 to generate the remote power connection signal 234 to cause the remote switch circuit 238 in the remote unit 212 to be closed to once again to couple the remote unit 212 to the power conductor 208+ thereby connecting the load 210 of the remote unit 212 to the power distribution circuit 204. The capacitor C₁ in the remote unit 212 is charged by the power source 206 when the remote unit 212 is coupled to the power conductors 208+, 208−. The energy stored in the capacitor C₁ allows the remote unit 212 to continue to be powered during a testing phase when the remote switch circuit 238 is open. The period of time in which the remote switch circuit 238 is open is such that the discharge of the energy stored in the capacitor C₁ is sufficient to power the remote unit 212. A resistor R₁ is coupled across the remote switch circuit 238 to allow multiple drops/remote units 212 to be connected to the same remote power input 226. The overall equal parallel resistances can be a higher than the body/touch resistance of approximately 2 kOhms. The resistance of resistor R₁ can be increased by reducing capacitance C₁ to allow a faster charging time. Powering the switch control circuit 232 in the remote unit 212 from the management communications link 228 could avoid the need or desire to include resistor R₁ as the switch control circuit 232 would be capable of powering on faster and thus also synchronizing to the power distribution circuit 204 faster.

With continuing reference to FIG. 2, note that an optional current limiter circuit 240 can be provided in the remote unit 212 and coupled to the remote switch circuit 238. The current limiter circuit 240 is configured to limit and avoid an in-rush current, which may be identified by the power distribution circuit 204 as an overload. This can cause the controller circuit 220 in the power distribution circuit 204 to send the remote power connection signal 234 indicating the remote power disconnect state to the remote switch input 236 to open the remote switch circuit 238 in the remote unit 212 to decouple the remote unit 212 from power conductor 208+, thereby disconnecting the load of the remote unit 212 from the power distribution circuit 204. A DC/DC converter 242 in the remote unit 212 can convert a high voltage from the power source 206 (e.g., 400 V) to the required operation voltage of the load 210 (e.g., 48 V). A power line 244 can be provided on the output side of the DC/DC converter 242 to provide an operational voltage to the switch control circuit 232 for operation. An optional load switch circuit 246 can also be provided between the current limiter circuit 240 and the load 210 to connect and disconnect the load 210 from the power conductor 208+. For example, the load switch circuit 246 may be under control of the switch control circuit 232.

In an alternative embodiment, the load switch circuit 246 can be locally controlled by the switch control circuit 232 by a pulse width modulated (PWM) signal, for example, instead of being controlled by the remote power connection signal 230. The PWM rate is set by the switch control circuit 232 to 0% initially. To switch control circuit 232 can gradually increase the PWM rate from 0% to 100% to control inrush current. This can also allow the current limiter circuit 240 to be eliminated, if desired, but elimination or presence is not required.

In this example in FIG. 2, a fast distribution power connection control signal 222 is employed that is implemented at a lower protocol level for the efficiency of the power transfer, as it allows shorter load disconnect time, as the power transfer is done during the load connecting time. A management signal that is implemented at higher protocol level is subjected to a relatively high delay variation. In one example, the distribution power connection control signal 222 is implemented in the physical level only in order to optimize it to the minimum possible delay variation or jitter. An improved timing synchronization between the controller circuit 220 and the load disconnect control may allow for a shorter load disconnecting time needed for the controller circuit 220 to check for lower current detection. In case of high delay variation, the disconnect time should be larger in order to ensure additional margin in order to allow current measurement to be conducted when there is higher confidence that the load 210 is disconnected.

The power distribution circuit 204 also includes a positive distribution power input 248I(P) configured to receive current distributed by the power source 206. A negative distribution power input 248I(N) provides a return path for the current. The power distribution circuit 204 also includes a distribution power output 2480 configured to distribute the received current over the power conductor 208+ coupled to the remote unit 212. The remote unit 212 coupled to the power distribution circuit 204 is deemed assigned to the power distribution circuit 204. The distribution switch circuit 224 is coupled between the positive distribution power input 248I(P) and the distribution power output 2480. The distribution switch circuit 224 includes a distribution switch control input 2501 configured to receive the distribution power connection control signal 222 indicating the distribution power connection mode, which is either a distribution power connect state or a distribution power disconnect state. For example, the distribution power connection mode may be indicated by a bit in the distribution power connection control signal 222, where a ‘1’ bit is a distribution power connect state and a ‘0’ bit is a distribution power disconnect state, or vice versa. The distribution switch circuit 224 is configured to be closed to couple the positive distribution power input 248I(P) to the distribution power output 2480 in response to the distribution power connection mode of the distribution power connection control signal 222 indicating the distribution power connect state. The distribution switch circuit 224 is further configured to be opened to decouple the positive distribution power input 248I(P) from the distribution power output 2480 in response to the distribution power connection mode of the distribution power connection control signal 222 indicating the distribution power disconnect state.

With continuing reference to FIG. 2, the current measurement circuit 214 of the power distribution circuit 204 is coupled to the distribution power output 2480. The current measurement circuit 214 includes a current measurement output 2520. The current measurement circuit 214 is configured to measure a current at (i.e., flowing to) the distribution power output 2480 and generate a current measurement 254 on the current measurement output 2520 based on the measured current at the distribution power output 2480. The power distribution circuit 204 also includes a distribution management communications output 2560 coupled to the management communications link 228, which is coupled to the assigned remote unit 212. The controller circuit 220 includes a current measurement input 2581 communicatively coupled to current measurement output 2520 of the current measurement circuit 214.

In an alternative embodiment, with reference to FIG. 2, the need to provide the management communications link 228 between the controller circuit 220 in the power distribution circuit 204 and the remote unit 212 to send the remote power connection signal 230 indicating a remote power disconnect state to the switch control circuit 232 in the remote unit 212 can be avoided if desired. For example, the remote unit 212 could be configured to cause the switch control circuit 232 (or the switch control circuit 232 itself could be configured to) periodically open the remote switch circuit 238 to decouple the remote unit 212 from power conductor 208+ thereby disconnecting the load 210 of the remote unit 212 from the power distribution circuit 204. The remote unit 212 and/or the switch control circuit 232 can synchronize to the controller circuit 220 generating the distribution power connection control signal 222 to the distribution switch circuit 224 to disconnect the power source 206 from the power conductors 208+, 208−.

For example, the switch control circuit 232 in the remote unit 212 can be configured to monitor changes in current I₁ on the power conductor 208+. The current I₁ will drop each time the distribution switch circuit 224 disconnects the power source 206 from the power conductors 208+, 208−, thereby disconnecting the load 210 of the remote unit 212 from the power distribution circuit 204. For example, the controller circuit 220 can be configured to disconnect the remote unit 212 every 2 ms. The remote switch circuit 238 can synchronize to this periodic disconnection event in a short period of time. Thus, if the switch control circuit 232 does not see a current or voltage drop on power conductor 208+ within a predefined period of time when expected according to the expected periodic disconnect time according to the timing determined by synchronization process, the switch control circuit 232 can open the remote switch circuit 238 to decouple the remote unit 212 from power conductor 208+ thereby disconnecting the load of the remote unit 212 from the power distribution circuit 204. The switch control circuit 232 can close the remote switch circuit 238 to recouple the remote unit 212 to the power conductor 208+ thereby connecting the load 210 of the remote unit 212 to the power distribution circuit 204 based on the expected timing of when the power distribution circuit 204 will close the distribution switch circuit 224 according to the timing determined by synchronization process. The discussion of further operation of the power distribution circuit 204 and the remote unit 212 discussed above for measuring current on the power conductors 208+, 208− is also applicable for this embodiment.

In a second alternative exemplary embodiment, to avoid the need to provide a separate management communications link 228 between the controller circuit 220 and the switch control circuit 232, the controller circuit 220 could be configured to periodically drop the output voltage on the power conductor 208+ to a known voltage level (e.g., from 350 VDC to 300 VDC). This dropping of the output voltage on the power conductor 208+ can be performed before communicating the distribution power connection control signal 222 indicating a distribution power disconnect state to the distribution switch circuit 224 to cause the distribution switch circuit 224 to be opened to decouple the power source 206 from the power conductors 208+, 208−. The remote unit 212 and/or the switch control circuit 232 therein can be configured to monitor the voltage on the power conductor 208+ to identify this voltage drop as a remote power connection signal 230 indicating a remote power disconnect state. In response, the switch control circuit 232 can open the remote switch circuit 238 to decouple the remote unit 212 from the power conductor 208+ thereby disconnecting the load 210 of the remote unit 212 from the power distribution circuit 204. The remote unit 212 and/or the switch control circuit 232 can wait a predefined period of time to close the remote switch circuit 238 to recouple the remote unit 212 to the power conductor 208+ thereby connecting the load 210 of the remote unit 212 to the power distribution circuit 204 based on the expected timing of when the power distribution circuit 204 will close the distribution switch circuit 224 according to the timing determined by synchronization process. The discussion of further operation of the power distribution circuit 204 and the remote unit 212 discussed above for measuring current on the power conductors 208+, 208− is also applicable for this embodiment.

In a third alternative exemplary embodiment, for the management communications link 228 between the controller circuit 220 and the switch control circuit 232, the controller circuit 220 could be configured to periodically drop the output voltage on the power conductor 208+ to a known voltage level (e.g., from 350 VDC to 300 VDC) before communicating the distribution power connection control signal 222 indicating a distribution power disconnect state to the distribution switch circuit 224 to cause the distribution switch circuit 224 to be opened to decouple the power source 206 from the power conductors 208+, 208−. The remote unit 212 and/or the switch control circuit 232 therein can be configured to monitor the voltage on the power conductor 208+ to identify this voltage drop as a remote power connection signal 230 indicating a remote power disconnect state. In response, the switch control circuit 232 can open the remote switch circuit 238 to decouple the remote unit 212 from the power conductor 208+ thereby disconnecting the load 210 of the remote unit 212 from the power distribution circuit 204. The remote unit 212 and/or the switch control circuit 232 can wait a predefined period of time to close the remote switch circuit 238 to recouple the remote unit 212 to the power conductor 208+ thereby connecting the load 210 of the remote unit 212 to the power distribution circuit 204 based on the expected timing of when the power distribution circuit 204 will close the distribution switch circuit 224 according to the timing determined by synchronization process. The discussion of further operation of the power distribution circuit 204 and the remote unit 212 discussed above for measuring current on the power conductors 208+, 208− is also applicable for this embodiment.

FIG. 3 is a timing diagram 300 illustrating an exemplary timing sequence 302 of the controller circuit 220 in the power distribution circuit 204 in the power distribution system 200 in FIG. 2. The timing sequence 302 shows exemplary timing of the power source 206 being coupled to the remote unit 212 for normal operation. The timing sequence 302 also shows the power source 206 being decoupled from the remote unit 212 in a testing operation to detect the external load 218 in contact with the power conductors 208+, 208−. As shown in FIG. 3, the remote power connect state and remote power disconnect state of the remote switch circuit 238 as controlled by the controller circuit 220 is shown as “CLOSE” states starting at times T₀, T₂, T₄, T₆, etc., in normal operation phases and “OPEN” states starting at times T₁, T₃, T₅, T₇, etc., in testing phases. The period of time between times T₁-T₂, T₃-T₄, and T₅-T₆ when the remote switch circuit 238 is open is controlled such that energy stored in the capacitor C₁ when the remote switch circuit 238 is closed is sufficient to power the remote unit 212 during the testing phases. The current measurement circuit 214 measures the current I₂ flowing through the power conductors 208+, 208− in FIG. 2. To avoid leakage, in one example, the capacitor C₁ can be charged with a low current when the remote switch circuit 238 is open, meaning off. Once the capacitor C₁ is charged to a high enough voltage such that the switch control circuit 232 can identify the remote power connection signal 230, the remote switch circuit 238 can be turned on and off periodically as discussed above.

Between times T₁-T₂, T₃-T₄, and T₅-T₆, when the remote switch circuit 238 is open, decoupling the remote unit 212 from the power conductors 208+, 208−, the controller circuit 220 detects no current flowing as an indication that the external load 218 is not contacting the power conductors 208+, 208−. However, as shown in FIG. 3, after time T₇, the current measurement circuit 214 measures a current I₂ which is detected by the controller circuit 220, which is indicative of the external load 218 being in contact with the power conductors 208+, 208−. If the controller circuit 220 detects the current I₂ exceeding the predefined threshold current level, this indicates the external load 218 being in contact with the power conductors 208+, 208−. The controller circuit 220 detects the current I₂ exceeding the predefined threshold current level shown at 304 in FIG. 3 within a detection time 306. In response, as shown in FIG. 3, the controller circuit 220 will communicate the distribution power connection control signal 222 indicating a distribution power disconnect state to the distribution switch circuit 224 to cause the distribution switch circuit 224 to be opened to decouple the power source 206 from the power conductors 208+, 208− for safety reasons.

In one example, the power distribution circuit 204 in FIG. 2 is designed in such a way that the close period of the distribution switch circuit 224 plus the detection time 306 of current measurement circuit 214 (see FIG. 3) will be lower than 10 ms, assuming that the time between current detection and the disconnection of the power source 206 from the power conductors 208+, 208− by distribution switch circuit 224 is negligible. This is because the current measurement circuit 214 measured the current I₂ from the connected power source 206 to detect the external load 218, as opposed to detecting the external load 218 through indirect methods, such as through the discharge of stored energy in the capacitor C₁ that is charged when a power source is connected and discharges during a testing phase when the power source is disconnected. In the power distribution circuit 204 in FIG. 2, the power source 206 is not decoupled from the power conductors 208+, 208− during the testing phase when the current measurement circuit 214 is measuring current I₂. As another example, the power distribution circuit 204 may be configured to detect a body in contact with the power conductors 208+, 208− and cause the distribution switch circuit 224 to be opened in response within approximately 10 ms or less at a 200 mA body current. The power distribution circuit 204 may be also configured to detect a body in contact with the power conductors 208+, 208− within approximately 20 ms or less at a 100 mA body current or less.

Further, as shown in the timing diagram 300 in FIG. 3, when the distribution switch circuit 224 is opened by the controller circuit 220 in response to detection of an unsafe condition by detection of an external load 218 when the remote switch circuit 238 is open, the voltage V on the power conductor 208+ does not immediately discharge to 0 Volts. The power conductor 208+ starts to discharge at discharge time T_{D-1} and does not fully discharge to approximately 0 V until discharge time T_{D-2}. This is due to residual energy in the form of charge which can be built up on the power conductor 208+ due to its parasitic capacitance. The capacitance in electrical components in the power source 206 and the remote unit 212 coupled to the power conductors 208+, 208− can also contribute towards this parasitic capacitance. When a remote unit 212 in the power distribution system 200 periodically disconnects its power consuming components from the power conductor 208+ as discussed above to allow the controller circuit 220 to detect if an unsafe condition exists, the built up charge on the power conductor 208+ is present. It takes time for the residual charge on the power conductor 208+ to discharge after the remote unit 212 is disconnected. This residual charge on the power conductors 208+, 208− can expose a person to a voltage charge longer than desired if a person is touching the power conductors 208+, 208− in an unsafe manner. Also, if the power source 206 is configured to regulate the off voltage time on the power conductors 208+, 208− during disconnect times to allow for the remote power connection signal 230 to be communicated over the power conductor 208+, residual charge on the power conductor 208+ can delay these communications. The time it takes for residual charge on the power conductor 208+ to be discharged is shown in 308 in the timing diagram 300 in FIG. 3. This discharge time may need to be accounted for before voltage signaling can be performed to provide communications.

In this regard, FIGS. 4A and 4B are schematic diagrams illustrating another exemplary power distribution system 400 that can be included in a DCS 402, wherein the power distribution system 400 is configured to perform a line capacitance discharge of power conductors 208+/208− between the power source 206 and a remote unit 212 when a safety disconnect of the power source 206 is performed. By actively discharging the power conductors 208+/208− during remote unit 212 disconnect times, a person may be exposed less time to charge on the power conductors 208+/208−. Further, communication signaling on the power conductors 208+/208− may be able to be performed faster. Being able to perform communication signaling faster over the power conductors 208+/208− may also allow the overall disconnection times to be reduced for more effective power transfer. Common components between the power distribution system 400 in FIGS. 4A and 4B and the power distribution system 200 in FIG. 2 are shown with common element numbers between FIG. 2 and FIGS. 4A and 4B and thus are not re-described.

In this regard, the power distribution system 400 in FIG. 4A includes a line discharge circuit 406 that is coupled to the power conductors 208+, 208− and the controller circuit 220. FIG. 4B illustrates a closer up view of the line discharge circuit 406 in the power distribution system 400 in FIG. 4A. The line discharge circuit 406 includes a line discharge switch 408 that is coupled between power conductor 208+ and a resistor circuit 410, which may be a resistor. The resistor circuit 410 is coupled to the power conductor 208. Thus, when the line discharge switch 408 is open, there is no current path from the power conductor 208+ through the resistor circuit 410 and to the power conductor 208−. However, when the line discharge switch 408 is closed, there is a current path from the power conductor 208+ through the resistor circuit 410 and the power conductor 208−. The controller circuit 220 includes a line discharge output 4120 that is coupled to the line discharge switch 408 to control its opening and closing. The controller circuit 220 is configured to issue a line discharge signal 411 that indicates an opening or closing state to either open or close the line discharge switch 408. For example, the line discharge switch 408 could be a power transistor, such as a BJT transistor where the line discharge output 4120 is coupled to a base of the transistor, and the collector and emitter of the transistor is coupled to the power conductor 208+ and the resistor circuit 410, respectively. With regard to FIG. 4A, the controller circuit 220 is configured to issue the line discharge signal 411 in an open state to open the line discharge switch 408 during normal power distribution. This prevents power from the power source 206 from being divided between the line discharge circuit 406 and the remote unit 212. However, when the controller circuit 220 determines that the measured current I₂ exceeds the predefined threshold current level indicating that the external load 218 is contacting the power conductor 208+ or 208− when the remote unit 212 is decoupled from the power conductor 208+, the controller circuit 220, in addition to opening the distribution switch circuit 224 can also be configured to issue the line discharge signal 411 in a closed state. This causes the line discharge switch 408 to close to allow any built up residual charge on the power conductor 208+ to be discharged through the resistor circuit 410 to the power conductor 208−. When the controller circuit 220 determines that the distribution switch circuit 224 can again be closed as discussed above, the controller circuit 220 can be configured to issue the line discharge signal 411 in an open state to cause the line discharge switch 408 to be open again.

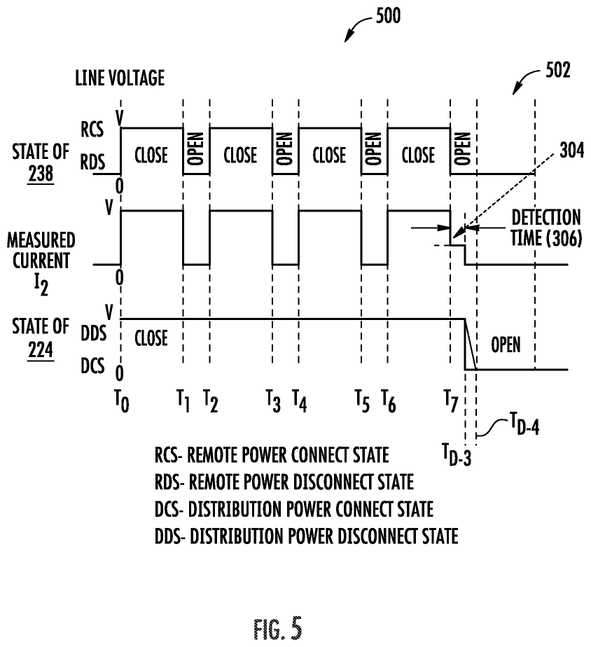

FIG. 5 is a timing diagram 500 illustrating an exemplary timing sequence 502 of the controller circuit 220 in the power distribution circuit 404 in the power distribution system 400 in FIGS. 4A and 4B. The timing sequence 502 shows exemplary timing of the power source 206 being coupled to the remote unit 212 for normal operation. The timing sequence 502 also shows the power source 206 being decoupled from the remote unit 212 in a testing operation to detect the external load 218 in contact with the power conductors 208+, 208−. As shown in FIG. 5, the remote power connect state and remote power disconnect state of the remote switch circuit 238 as controlled by the controller circuit 220 is shown as “CLOSE” states starting at time T₀, T₂, T₄, T₆, etc., in normal operation phases and “OPEN” states starting at time T₁, T₃, T₅, T₇, etc., in testing phases. The period of time between times T₁-T₂, T₃-T₄, and T₅-T₆ when the remote switch circuit 238 is open is controlled such that energy stored in the capacitor C₁ when the remote switch circuit 238 is closed is sufficient to power the remote unit 212 during the testing phases. The current measurement circuit 214 measures the current I₂ flowing through the power conductors 208+, 208− in FIG. 4. To avoid leakage, in one example, the capacitor C₁ can be charged with a low current when the remote switch circuit 238 is open, meaning off. Once capacitor C₁ is charged to a high enough voltage such that the switch control circuit 232 can identify the remote power connection signal 230, and the remote switch circuit 238 can be turned on and off periodically as discussed above.

Between times T₁-T₂, T₃-T₄, and T₅-T₆, when the remote switch circuit 238 is open decoupling the remote unit 212 from the power conductors 208+, 208−, the controller circuit 220 detects no current flowing as an indication that the external load 218 is not contacting the power conductors 208+, 208−. However, as shown in FIG. 5, after time T₇, the current measurement circuit 214 measures a current I₂ which is detected by the controller circuit 220, which is indicative of the external load 218 being in contact with the power conductors 208+, 208−. If the controller circuit 220 detects the current I₂ exceeding the predefined threshold current level, this indicates the external load 218 being in contact with the power conductors 208+, 208−. The controller circuit 220 detects the current I₂ exceeding the predefined threshold current level shown at 304 in FIG. 5 within the detection time 306. In response, as shown in FIG. 5, the controller circuit 220 will communicate the distribution power connection control signal 222 indicating a distribution power disconnect state to the distribution switch circuit 224 to cause the distribution switch circuit 224 to be opened to decouple the power source 206 from the power conductors 208+, 208− for safety reasons. The controller circuit 220 will also issue the line discharge signal 411 in a closed state to cause the line discharge switch 408 to be closed to allow any built up residual charge on the power conductor 208+ to be discharged through the resistor circuit 410 to the power conductor 208−.

In one example, the power distribution circuit 404 in FIG. 4A is designed in such a way that the close period of the distribution switch circuit 224 plus the detection time 306 of current measurement circuit 214 (see FIG. 5) will be lower than 10 ms, assuming that the time between current detection and the disconnection of the power source 206 from the power conductors 208+, 208− by the distribution switch circuit 224 is negligible. This is because the current measurement circuit 214 measures the current from the connected power source 206 to detect the external load 218, as opposed to detecting the external load 218 through indirect methods, such as through the discharge of stored energy in capacitor C₁ that is charged when a power source is connected and discharges during a testing phase when the power source is disconnected. In the power distribution circuit 404 in FIG. 4, the power source 206 is not decoupled from the power conductors 208+, 208− during the testing phase when the current measurement circuit 214 is measuring current I₂. As another example, the power distribution circuit 204 may be configured to detect a body in contact with the power conductors 208+, 208− and cause the distribution switch circuit 224 to be opened in response within approximately 10 ms or less at a 200 mA body current. The power distribution circuit 204 may be also configured to detect a body in contact with the power conductors 208+, 208− within approximately 20 ms or less at a 100 mA body current or less.

Further, as shown in the timing diagram 500 in FIG. 5, when the distribution switch circuit 224 is opened by the controller circuit 220 in response to detection of an unsafe condition by detection of an external load 218 when the remote switch circuit 238 is open, the voltage V on the power conductor 208+ more immediately discharges to approximately 0 Volts as opposed to the power distribution system 200 in FIG. 2 and shown in FIG. 3 discussed above. The power conductor 208+ starts to discharge at discharge time T_{D-3} and discharges to 0 V at time T_{D-4}. This is because the controller circuit 220 will also issue the line discharge signal 411 in a closed state to cause the line discharge switch 408 to be closed to allow any built up residual charge on the power conductor 208+ to be discharged through the resistor circuit 410 to the power conductor 208−.

The controller circuit 220 can be configured to issue the line discharge signal 411 in an open state to cause the line discharge switch 408 to be opened after discharge of residual charge on the power conductor 208+ after a predetermined amount of time. This predetermined amount of time can be based on when the controller circuit 220 issues the distribution power connection control signal 222 of a distribution power disconnect state to cause the distribution switch circuit 224 to be closed once again to couple the power source 206 from the current measurement circuit 214 and the power conductor 208+. Alternatively, the controller circuit 220 can be configured to receive a current signal 414 from a node coupled to the line discharge circuit 406 as shown in FIGS. 4A and 4B as a feedback mechanism to determine when the power conductor 208+ has been discharged below a threshold charge level and/or to zero charge (e.g., by measuring current or voltage). The controller circuit 220 can be configured to issue the line discharge signal 411 in a closed state to cause the line discharge switch 408 to be closed again after it has been determined based on the current signal 414 that the residual charge on the power conductor 208+ has been fully discharged or sufficiently discharged at or below a predetermined threshold charge level.

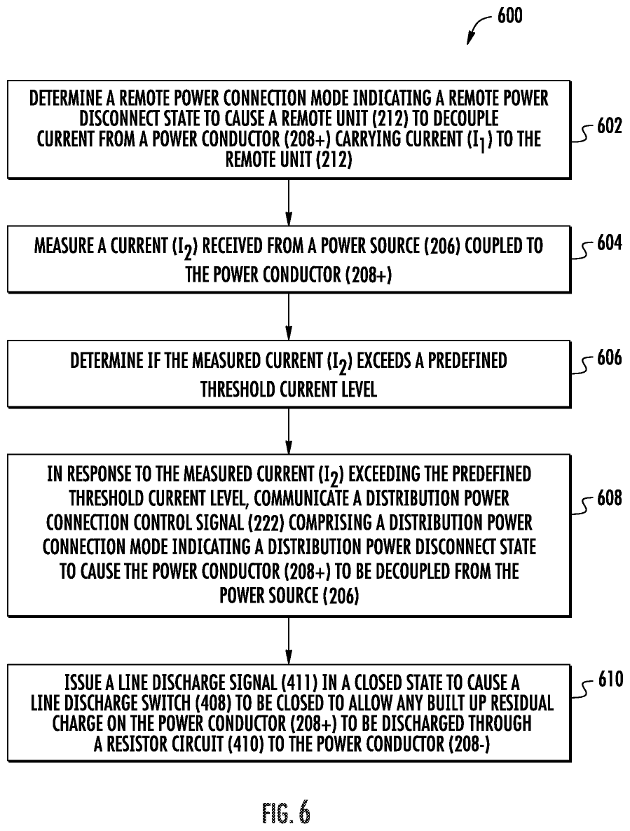

FIG. 6 is a flowchart illustrating an exemplary process 600 of the controller circuit 220 in the power distribution system 400 in FIGS. 4A and 4B performing a line capacitance discharge of power conductors 208+, 208− in response to a remote unit(s) 212 decoupling from the power source 206 in a testing phase and performing a safety disconnect. As shown in the exemplary process 600 in FIG. 6 referencing the power distribution system 400 in FIG. 4A, in one example option, the controller circuit 220 is configured to communicate the remote power connection signal 230 comprising a remote power connection mode indicating a remote power disconnect state over the distribution management communications output 2560 coupled to the assigned remote unit 212 to cause the remote switch circuit 238 to open and decouple the remote unit 212 from the power conductor 208+ carrying the current I₁ (block 602 in FIG. 6). The controller circuit 220 is also configured to measure a current I₂ received from the power source 206 coupled to the power conductor 208+(block 604 in FIG. 6). The controller circuit 220 is configured to determine if the measured current I₂ on the current measurement input 2581 exceeds a predefined threshold current level (block 606 in FIG. 6). In response to the measured current I₂ exceeding the predefined threshold current level indicating that the external load 218 is contacting the power conductor 208+ or 208, the controller circuit 220 is configured to communicate the distribution power connection control signal 222 comprising the distribution power connection mode indicating the distribution power disconnect state to the distribution switch control input 2501 to cause the distribution switch circuit 224 to open to decouple the power source 206 from the current measurement circuit 214 and the power conductor 208+(block 608 in FIG. 6). For example, the predefined threshold current level may be less than or equal to 200 mA or less than or equal to 100 mA, as examples. If instead, the measured current I₂ of the power distribution circuit 404 does not exceed the predefined threshold current level, the controller circuit 220 is configured to communicate the distribution power connection control signal 222 to provide the distribution power connection mode indicating the distribution power connect state to the distribution switch control input 2501. This causes the distribution switch circuit 224 to close or continue to be closed and couple or continue to couple the power source 206 to the current measurement circuit 214 and the power conductor 208+ for providing power to the remote unit 212.

With continuing reference to FIG. 6, in response to the measured current I₂ exceeding the predefined threshold current level indicating that the external load 218 is contacting the power conductor 208+ or 208 (block 608), the controller circuit 220 will also issue the line discharge signal 411 in a closed state to cause the line discharge switch 408 to be closed to allow any built up residual charge on the power conductor 208+ to be discharged through the resistor circuit 410 to the power conductor 208− (block 610).

With reference to FIG. 4A, the controller circuit 220 is also configured to communicate the remote power connection signal 230 comprising the remote power connection mode indicating the remote power disconnect state over the distribution management communications output 2560 before determining if the measured current I₂ on the current measurement input 2581 exceeds a predefined threshold current level. This causes the remote switch circuit 238 to open to decouple the remote unit 212 from the power conductors 208+ or 208−. This is so that when it is desired to test to determine if the external load 218 is contacting the power conductors 208+ or 208−, the remote unit 212 is decoupled from the power conductors 208+ or 208− so that the load 210 of the remote unit 212 is not causing a current to be drawn from the power source 206. In this manner, any measured current I₂ on the current measurement input 2581 is an indication of the external load 218 contacting the power conductors 208+ or 208− and not the load 210 of the remote unit 212. As previously discussed, the energy stored in the capacitor C₁ when the remote unit 212 is coupled to the power conductors 208+ or 208− allows the remote unit 212 to continue to be powered during the testing phase when the remote switch circuit 238 is open.

With continuing reference to FIG. 4A, after the testing phase, the controller circuit 220 after a predefined period of time is configured to communicate the remote power connection signal 230 with a remote power connection mode indicating a remote power connect state over the distribution management communications output 2560 and over the management communications link 228. This causes the remote switch circuit 238 to close so that the remote unit 212 is again coupled to the power conductor 208+ to receive power from the power distribution circuit 204. The controller circuit 220 may be configured to communicate the remote power connection signal 230 with a remote power connection mode indicating a remote power connect state over the distribution management communications output 2560 after a predefined period of time has elapsed communicating the remote power connection signal 230 with a remote power connection mode indicating a remote power disconnect state. The controller circuit 220 will then issue the line discharge signal 411 in an open state to cause the line discharge switch 408 to be opened so that the power conductor 208+ is not discharged through the resistor circuit 410 to the power conductor 208−. The controller circuit 220 then issues the distribution power connection control signal 222 to cause the distribution switch circuit 224 to be closed to recouple the power source 206 to the remote unit 212.

The controller circuit 220 may be configured to initially communicate the remote power connection signal 230 of the remote power connection mode indicating the remote power connect state before communicating the remote power connection signal 230 of the remote power connection mode indicating the remote power disconnect state, so that the remote unit 212 is initially powered by the power distribution circuit 204 before any testing phases begin. As previously discussed, the controller circuit 220 may be configured to repeatedly communicate the remote power connection signal 230 of the remote power connection mode indicating the remote power connect state during a normal operation phase, and then communicate the remote power connection signal 230 of the remote power connection mode indicating the remote power disconnect state during a testing phase to continuously detect the external load 218 contacting the power conductors 208+, 208−.

Note that any of the referenced inputs herein can be provided as input ports or circuits, any of the referenced outputs herein can be provided as output ports or circuits.

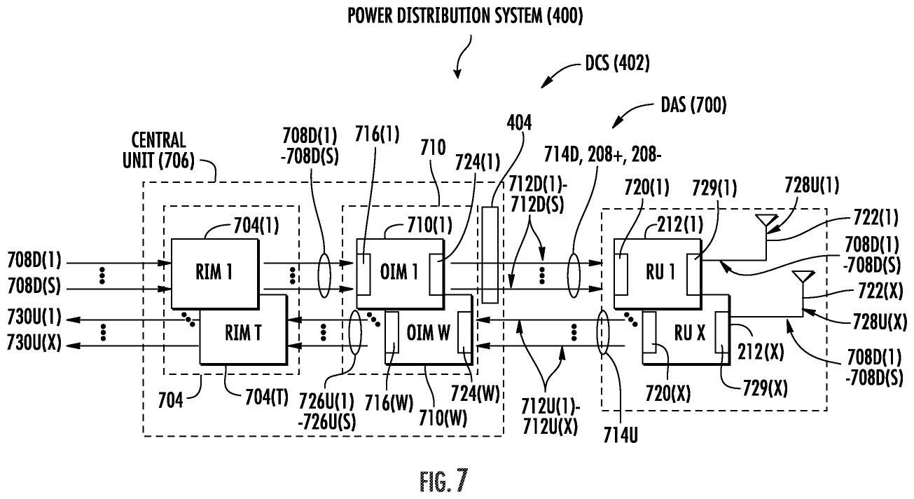

FIG. 7 is a schematic diagram of an exemplary optical-fiber based DAS 700 in which a power distribution system configured to perform a line capacitance discharge of power conductors between a power source and a remote unit(s) when a safety disconnect of the power source is performed in response to a measured current from the connected power source when the remote unit is decoupled from the power source, including the power distribution system in FIGS. 4A and 4B, can be provided. In this example, the power distribution system 400 is provided in a DCS 402, which is a distributed antenna system (DAS) 700 in this example. Note that the power distribution circuit 404 is not limited to being provided in a DCS. A DAS is a system that is configured to distribute communications signals, including wireless communications signals, from a central unit to a plurality of remote units over physical communications media, to then be distributed from the remote units wirelessly to client devices in wireless communication range of a remote unit. The DAS 700 in this example is an optical fiber-based DAS that is comprised of three (3) main components. One or more radio interface circuits provided in the form of radio interface modules (RIMs) 704(1)-704(T) are provided in a central unit 706 to receive and process downlink electrical communications signals 708D(1)-708D(S) prior to optical conversion into downlink optical communications signals. The downlink electrical communications signals 708D(1)-708D(S) may be received from a base transceiver station (BTS) or baseband unit (BBU) as examples. The downlink electrical communications signals 708D(1)-708D(S) may be analog signals or digital signals that can be sampled and processed as digital information. The RIMS 704(1)-704(T) provide both downlink and uplink interfaces for signal processing. The notations “1-S” and “1-T” indicate that any number of the referenced component, 1-S and 1-T, respectively, may be provided.

With continuing reference to FIG. 7, the central unit 706 is configured to accept the plurality of RIMS 704(1)-704(T) as modular components that can easily be installed and removed or replaced in a chassis. In one embodiment, the central unit 706 is configured to support up to twelve (12) RIMs 704(1)-704(12). Each RIM 704(1)-704(T) can be designed to support a particular type of radio source or range of radio sources (i.e., frequencies) to provide flexibility in configuring the central unit 706 and the DAS 700 to support the desired radio sources. For example, one RIM 704 may be configured to support the Personal Communication Services (PCS) radio band. Another RIM 704 may be configured to support the 700 MHz radio band. In this example, by inclusion of these RIMS 704, the central unit 706 could be configured to support and distribute communications signals, including those for the communications services and communications bands described above as examples.

The RIMs 704(1)-704(T) may be provided in the central unit 706 that support any frequencies desired, including but not limited to licensed US FCC and Industry Canada frequencies (824-849 MHz on uplink and 869-894 MHz on downlink), US FCC and Industry Canada frequencies (1850-1915 MHz on uplink and 1930-1995 MHz on downlink), US FCC and Industry Canada frequencies (1710-1755 MHz on uplink and 2110-2155 MHz on downlink), US FCC frequencies (698-716 MHz and 776-787 MHz on uplink and 728-746 MHz on downlink), EU R & TTE frequencies (880-915 MHz on uplink and 925-960 MHz on downlink), EU R & TTE frequencies (1710-1785 MHz on uplink and 1805-1880 MHz on downlink), EU R & TTE frequencies (1920-1980 MHz on uplink and 2110-2170 MHz on downlink), US FCC frequencies (806-824 MHz on uplink and 851-869 MHz on downlink), US FCC frequencies (896-901 MHz on uplink and 929-941 MHz on downlink), US FCC frequencies (793-805 MHz on uplink and 763-775 MHz on downlink), and US FCC frequencies (2495-2690 MHz on uplink and downlink).

With continuing reference to FIG. 7, the received downlink electrical communications signals 708D(1)-708D(S) are provided to a plurality of optical interfaces provided in the form of optical interface modules (OIMs) 710(1)-710(W) in this embodiment to convert the downlink electrical communications signals 708D(1)-708D(S) into downlink optical communications signals 712D(1)-712D(S). The notation “1-W” indicates that any number of the referenced component 1-W may be provided. The OIMs 710(1)-710(W) may include one or more optical interface components (OICs) that contain electrical-to-optical (E-O) converters 716(1)-716(W) to convert the received downlink electrical communications signals 708D(1)-708D(S) into the downlink optical communications signals 712D(1)-712D(S). The OIMs 710(1)-710(W) support the radio bands that can be provided by the RIMs 704(1)-710(T), including the examples previously described above. The downlink optical communications signals 712D(1)-712D(S) are communicated over a downlink optical fiber communications link 714D to a plurality of remote units 212(1)-212(X) provided in the form of remote units in this example. The notation “1-X” indicates that any number of the referenced component 1-X may be provided. One or more of the downlink optical communications signals 712D(1)-712D(S) can be distributed to each remote unit 212(1)-212(X). Thus, the distribution of the downlink optical communications signals 712D(1)-712D(S) from the central unit 706 to the remote units 212(1)-212(X) is in a point-to-multipoint configuration in this example.

With continuing reference to FIG. 7, the remote units 212(1)-212(X) include optical-to-electrical (O-E) converters 720(1)-720(X) configured to convert the one or more received downlink optical communications signals 712D(1)-712D(S) back into the downlink electrical communications signals 708D(1)-708D(S) to be wirelessly radiated through antennas 722(1)-722(X) in the remote units 212(1)-212(X) to user equipment (not shown) in the reception range of the antennas 722(1)-722(X). The OIMs 710(1)-710(W) may also include O-E converters 724(1)-724(W) to convert received uplink optical communications signals 712U(1)-712U(X) from the remote units 212(1)-212(X) into uplink electrical communications signals 726U(1)-726U(S) as will be described in more detail below.

With continuing reference to FIG. 7, the remote units 212(1)-212(X) are also configured to receive uplink electrical communications signals 728U(1)-728U(X) received by the respective antennas 722(1)-722(X) from client devices in wireless communication range of the remote units 212(1)-212(X). The uplink electrical communications signals 728U(1)-728U(S) may be analog signals or digital signals that can be sampled and processed as digital information. The remote units 212(1)-212(X) include E-O converters 729(1)-729(X) to convert the received uplink electrical communications signals 728U(1)-728U(X) into uplink optical communications signals 712U(1)-712U(X). The remote units 212(1)-212(X) distribute the uplink optical communications signals 712U(1)-712U(X) over an uplink optical fiber communications link 714U to the OIMs 710(1)-710(W) in the central unit 706. The O-E converters 724(1)-724(W) convert the received uplink optical communications signals 712U(1)-712U(X) into uplink electrical communications signals 730U(1)-730U(X), which are processed by the RIMs 704(1)-704(T) and provided as the uplink electrical communications signals 730U(1)-730U(X) to a source transceiver such as a base transceiver station (BTS) or baseband unit (BBU).

Note that the downlink optical fiber communications link 714D and the uplink optical fiber communications link 714U coupled between the central unit 706 and the remote units 212(1)-212(X) may be a common optical fiber communications link, wherein for example, wave division multiplexing (WDM) may be employed to carry the downlink optical communications signals 712D(1)-712D(S) and the uplink optical communications signals 712U(1)-712U(X) on the same optical fiber communications link. Alternatively, the downlink optical fiber communications link 714D and the uplink optical fiber communications link 714U coupled between the central unit 706 and the remote units 212(1)-212(X) may be single, separate optical fiber communications links, wherein for example, wave division multiplexing (WDM) may be employed to carry the downlink optical communications signals 712D(1)-712D(S) on one common downlink optical fiber and the uplink optical communications signals 712U(1)-712U(X) on a separate, only uplink optical fiber. Alternatively, the downlink optical fiber communications link 714D and the uplink optical fiber communications link 714U coupled between the central unit 706 and the remote units 212(1)-212(X) may be separate optical fibers dedicated to and providing a separate communications link between the central unit 706 and each remote unit 212(1)-212(X).

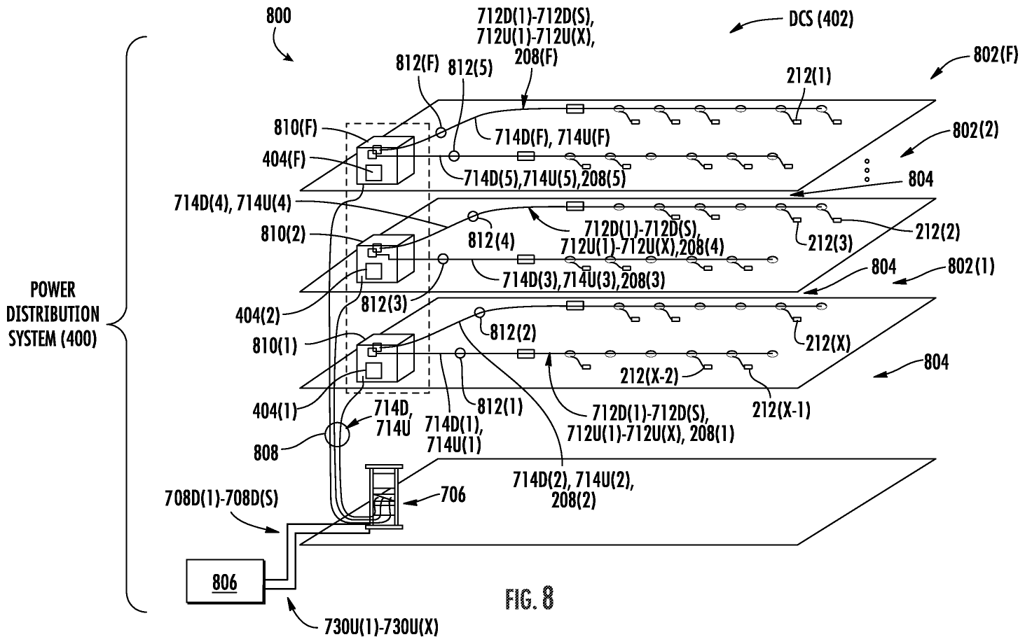

The DCS 402 and its power distribution system 400 in FIGS. 4A and 4B can be provided in an indoor environment as illustrated in FIG. 8. FIG. 8 is a partially schematic cut-away diagram of a building infrastructure 800 employing the DCS 402. The building infrastructure 800 in this embodiment includes a first (ground) floor 802(1), a second floor 802(2), and a Fth floor 802(F), where ‘F’ can represent any number of floors. The floors 802(1)-802(F) are serviced by the central unit 706 to provide antenna coverage areas 804 in the building infrastructure 800. The central unit 706 is communicatively coupled to a signal source 806, such as a BTS or BBU, to receive the downlink electrical communications signals 708D(1)-708D(S). The central unit 706 is communicatively coupled to the remote units 212(1)-212(X) to receive uplink optical communications signals 712U(1)-712U(X) from the remote units 212(1)-212(X) as previously described in FIG. 7. The downlink and uplink optical communications signals 712D(1)-712D(S), 712U(1)-712U(X) are distributed between the central unit 706 and the remote units 212(1)-212(X) over a riser cable 808 in this example. The riser cable 808 may be routed through interconnect units (ICUs) 810(1)-810(F) dedicated to each floor 802(1)-802(F) for routing the downlink and uplink optical communications signals 712D(1)-712D(S), 712U(1)-712U(X) to the remote units 212(1)-212(X). The ICUs 810(1)-810(F) may also include respective power distribution circuits 404(1)-404(F) that include power sources as part of the power distribution system 400, wherein the power distribution circuits 404(1)-404(F) are configured to distribute power remotely to the remote units 212(1)-212(X) to provide power for operating the power consuming components in the remote units 212(1)-212(X). For example, array cables 812(1)-812(F) may be provided and coupled between the ICUs 810(1)-810(F) that contain both optical fibers to provide the respective downlink and uplink optical fiber communications media 714D(1)-714D(F), 714U(1)-714U(F) and power conductors 208(1)-208(F) (e.g., electrical wire) to carry current from the respective power distribution circuits 404(1)-404(F) to the remote units 212(1)-212(X).

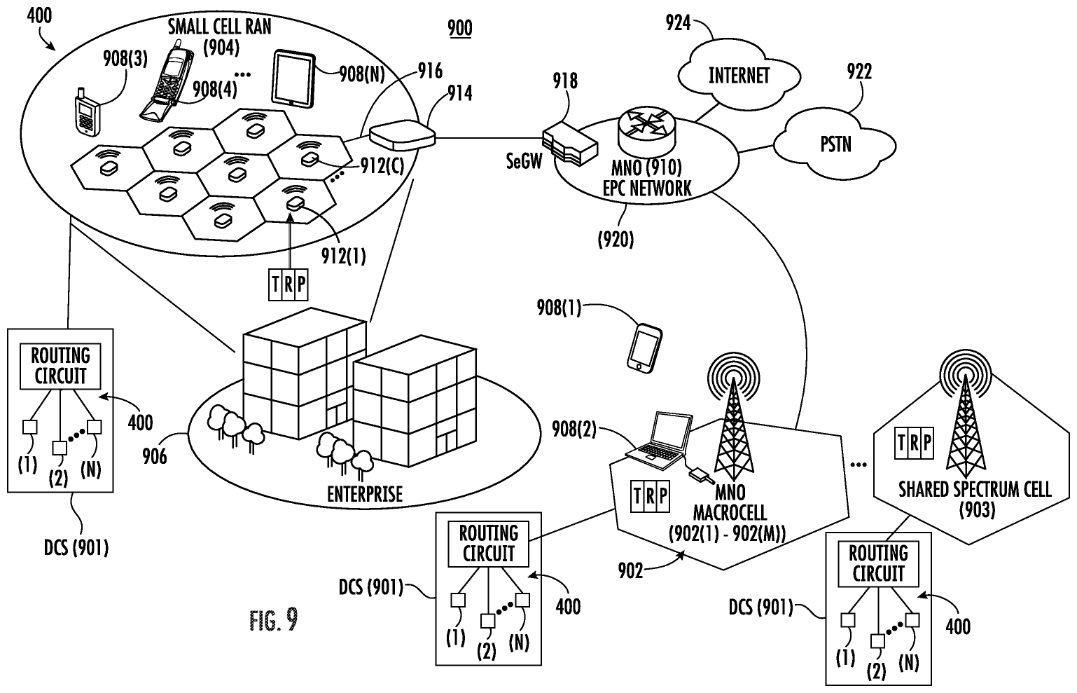

FIG. 9 is a schematic diagram of an exemplary mobile telecommunications environment 900 that includes an exemplary radio access network (RAN) that includes a mobile network operator (MNO) macrocell employing a radio node, a shared spectrum cell employing a radio node, an exemplary small cell RAN employing a multi-operator radio node located within an enterprise environment as DCSs, and that can include one or more power distribution systems, including the power distribution system 400 in FIGS. 4A and 4B. The environment 900 includes exemplary macrocell RANs 902(1)-902(M) (“macrocells 902(1)-902(M)”) and an exemplary small cell RAN 904 located within an enterprise environment 906 and configured to service mobile communications between a user mobile communications device 908(1)-908(N) to an MNO 910. A serving RAN for a user mobile communications device 908(1)-908(N) is a RAN or cell in the RAN in which the user mobile communications devices 908(1)-908(N) have an established communications session with the exchange of mobile communications signals for mobile communications. Thus, a serving RAN may also be referred to herein as a serving cell. For example, the user mobile communications devices 908(3)-908(N) in FIG. 9 are being serviced by the small cell RAN 904, whereas user mobile communications devices 908(1) and 908(2) are being serviced by the macrocell 902. The macrocell 902 is an MNO macrocell in this example. However, a shared spectrum RAN 903 (also referred to as “shared spectrum cell 903”) includes a macrocell in this example and supports communications on frequencies that are not solely licensed to a particular MNO and thus may service user mobile communications devices 908(1)-908(N) independent of a particular MNO. For example, the shared spectrum cell 903 may be operated by a third party that is not an MNO and wherein the shared spectrum cell 903 supports CBRS. Also, as shown in FIG. 9, the MNO macrocell 902, the shared spectrum cell 903, and/or the small cell RAN 904 can interface with a shared spectrum DCS 901 supporting coordination of distribution of shared spectrum from multiple service providers to remote units to be distributed to subscriber devices. The MNO macrocell 902, the shared spectrum cell 903, and the small cell RAN 904 may be neighboring radio access systems to each other, meaning that some or all can be in proximity to each other such that a user mobile communications device 908(3)-908(N) may be able to be in communications range of two or more of the MNO macrocell 902, the shared spectrum cell 903, and the small cell RAN 904 depending on the location of user mobile communications devices 908(3)-908(N).

In FIG. 9, the mobile telecommunications environment 900 in this example is arranged as an LTE (Long Term Evolution) system as described by the Third Generation Partnership Project (3GPP) as an evolution of the GSM/UMTS standards (Global System for Mobile communication/Universal Mobile Telecommunications System). It is emphasized, however, that the aspects described herein may also be applicable to other network types and protocols. The mobile telecommunications environment 900 includes the enterprise 906 in which the small cell RAN 904 is implemented. The small cell RAN 904 includes a plurality of small cell radio nodes 912(1)-912(C). Each small cell radio node 912(1)-912(C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated.

In FIG. 9, the small cell RAN 904 includes one or more services nodes (represented as a single services node 914) that manage and control the small cell radio nodes 912(1)-912(C). In alternative implementations, the management and control functionality may be incorporated into a radio node, distributed among nodes, or implemented remotely (i.e., using infrastructure external to the small cell RAN 904). The small cell radio nodes 912(1)-912(C) are coupled to the services node 914 over a direct or local area network (LAN) connection 916 as an example, typically using secure IPsec tunnels. The small cell radio nodes 912(1)-912(C) can include multi-operator radio nodes. The services node 914 aggregates voice and data traffic from the small cell radio nodes 912(1)-912(C) and provides connectivity over an IPsec tunnel to a security gateway (SeGW) 918 in a network 920 (e.g., evolved packet core (EPC) network in a 4G network, or 5G Core in a 5G network) of the MNO 910. The network 920 is typically configured to communicate with a public switched telephone network (PSTN) 922 to carry circuit-switched traffic, as well as for communicating with an external packet-switched network such as the Internet 924.

The environment 900 also generally includes a node (e.g., eNodeB or gNodeB) base station, or “macrocell” 902. The radio coverage area of the macrocell 902 is typically much larger than that of a small cell where the extent of coverage often depends on the base station configuration and surrounding geography. Thus, a given user mobile communications device 908(3)-908(N) may achieve connectivity to the network 920 (e.g., EPC network in a 4G network, or 5G Core in a 5G network) through either a macrocell 902 or small cell radio node 912(1)-912(C) in the small cell RAN 904 in the environment 900.

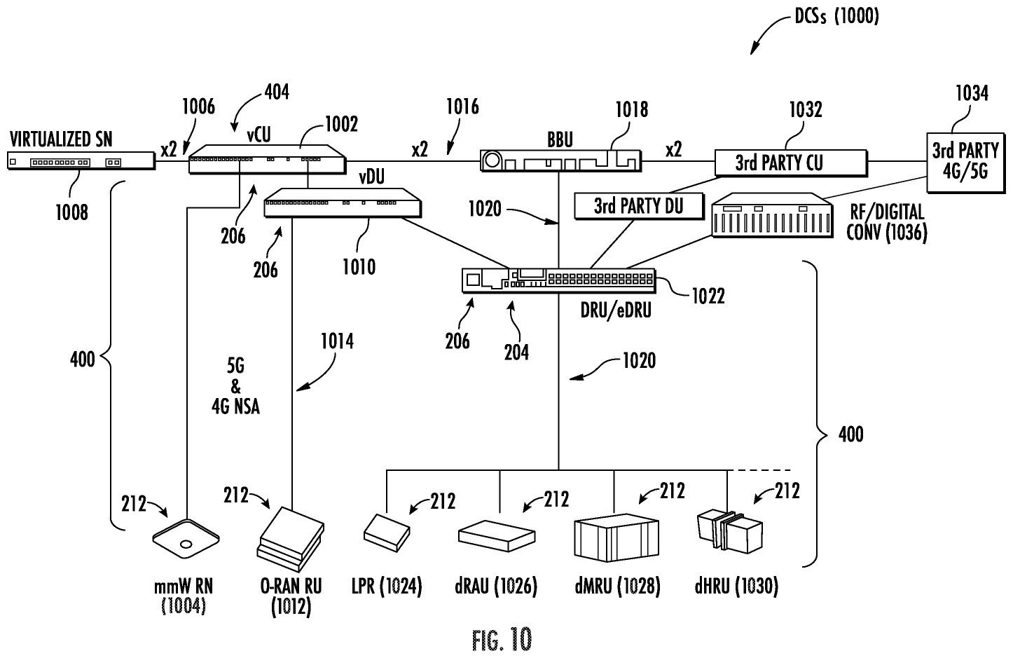

FIG. 10 is a schematic diagram illustrating exemplary DCSs 1000 that support 4G and 5G communications services. The DCSs 1000 in FIG. 10 can include one or more power distribution systems, including the power distribution system 400 in FIGS. 4A and 4B, configured to perform a line capacitance discharge of power conductors between a power source and a remote unit(s) when a safety disconnect of the power source is performed in response to a measured current from the connected power source when the remote unit is decoupled from the power source. The DCSs 1000 support both legacy 4G LTE, 4G/5G non-standalone (NSA), and 5G communications systems. As shown in FIG. 10, a centralized services node 1002 is provided that is configured to interface with a core network to exchange communications data and distribute the communications data as radio signals to remote units. In this example, the centralized services node 1002 is configured to support distributed communications services to a millimeter wave (mmW) radio node 1004. The functions of the centralized services node 1002 can be virtualized through an x2 interface 1006 to another services node 1008. The centralized services node 1002 can also include one or more internal radio nodes that are configured to be interfaced with a distribution node 1010 to distribute communications signals for the radio nodes to an open RAN (O-RAN) remote unit 1012 that is configured to be communicatively coupled through an O-RAN interface 1014.

The centralized services node 1002 can also be interfaced through an x2 interface 1016 to a baseband unit (BBU) 1018 that can provide a digital signal source to the centralized services node 1002. The BBU 1018 is configured to provide a signal source to the centralized services node 1002 to provide radio source signals 1020 to the O-RAN remote unit 1012 as well as to a distributed router unit (DRU) 1022 as part of a digital DAS. The DRU 1022 is configured to split and distribute the radio source signals 1020 to different types of remote units, including a lower power remote unit (LPR) 1024, a radio antenna unit (dRAU) 1026, a mid-power remote unit (dMRU) 1028, and a high power remote unit (dHRU) 1030. The BBU 1018 is also configured to interface with a third party central unit 1032 and/or an analog source 1034 through an RF/digital converter 1036.

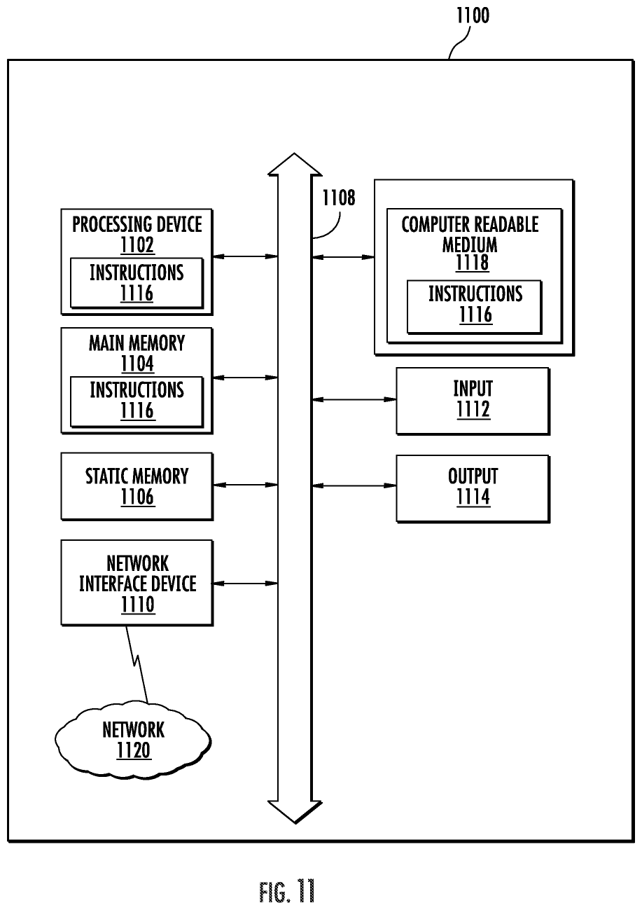

FIG. 11 is a schematic diagram representation of additional detail illustrating a computer system 1100 that could be employed in any component or circuit in power distribution system, including the power distribution system 400 in FIGS. 4A and 4B, configured to perform a line capacitance discharge of power conductors between a power source and a remote unit(s) when a safety disconnect of the power source is performed in response to a measured current from the connected power source when the remote unit is decoupled from the power source. In this regard, the computer system 1100 is adapted to execute instructions from an exemplary computer-readable medium to perform these and/or any of the functions or processing described herein. The computer system 1100 in FIG. 11 may include a set of instructions that may be executed to program and configure programmable digital signal processing circuits in a DCS for supporting scaling of supported communications services. The computer system 1100 may be connected (e.g., networked) to other machines in a LAN, an intranet, an extranet, or the Internet. While only a single device is illustrated, the term “device” shall also be taken to include any collection of devices that individually or jointly execute a set (or multiple sets) of instructions to perform any one or more of the methodologies discussed herein. The computer system 1100 may be a circuit or circuits included in an electronic board card, such as, a printed circuit board (PCB), a server, a personal computer, a desktop computer, a laptop computer, a personal digital assistant (PDA), a computing pad, a mobile device, or any other device, and may represent, for example, a server or a user's computer.

The exemplary computer system 1100 in this embodiment includes a processing device or processor 1102, a main memory 1104 (e.g., read-only memory (ROM), flash memory, dynamic random access memory (DRAM), such as synchronous DRAM (SDRAM), etc.), and a static memory 1106 (e.g., flash memory, static random access memory (SRAM), etc.), which may communicate with each other via a data bus 1108. Alternatively, the processor 1102 may be connected to the main memory 1104 and/or static memory 1106 directly or via some other connectivity means. The processor 1102 may be a controller, and the main memory 1104 or static memory 1106 may be any type of memory.

The processor 1102 represents one or more general-purpose processing devices, such as a microprocessor, central processing unit, or the like. More particularly, the processor 1102 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processor 1102 is configured to execute processing logic in instructions for performing the operations and steps discussed herein.

The computer system 1100 may further include a network interface device 1110. The computer system 1100 also may or may not include an input 1112, configured to receive input and selections to be communicated to the computer system 1100 when executing instructions. The computer system 1100 also may or may not include an output 1114, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 1100 may or may not include a data storage device that includes instructions 1116 stored in a computer-readable medium 1118. The instructions 1116 may also reside, completely or at least partially, within the main memory 1104 and/or within the processor 1102 during execution thereof by the computer system 1100, the main memory 1104 and the processor 1102 also constituting computer-readable medium. The instructions 1116 may further be transmitted or received over a network 1120 via the network interface device 1110.

While the computer-readable medium 1118 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.); and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components of the distributed antenna systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A power distribution system, comprising:
one or more power distribution circuits each comprising:
a distribution power input configured to receive current distributed by a power source;
a distribution power output configured to distribute the received current over a power conductor coupled to an assigned remote unit among a plurality of remote units;
a distribution switch circuit coupled between the distribution power input and the distribution power output, the distribution switch circuit comprising a distribution switch control input configured to receive a distribution power connection control signal indicating a distribution power connection mode;
the distribution switch circuit configured to be closed to couple the distribution power input to the distribution power output in response to the distribution power connection mode indicating a distribution power connect state; and
the distribution switch circuit further configured to be opened to decouple the distribution power input from the distribution power output in response to the distribution power connection mode indicating a distribution power disconnect state;
a current measurement circuit coupled to the distribution power output and comprising a current measurement output;
the current measurement circuit configured to measure a current at the distribution power output and generate a current measurement on the current measurement output based on the measured current at the distribution power output; and
a line discharge circuit comprising a line discharge switch coupled to the power conductor and configured to receive a line discharge signal, the line discharge switch configured to be closed in response to the line discharge signal indicating a closed state and the line discharge switch configured to be opened in response to the line discharge signal indicating an open state; and
a controller circuit comprising:
one or more current measurement inputs communicatively coupled to the one or more current measurement outputs of the one or more current measurement circuits of the one or more power distribution circuits; and
the controller circuit configured to, for a power distribution circuit among the one or more power distribution circuits:
generate the distribution power connection control signal indicating the distribution power connection mode to the distribution switch control input of the power distribution circuit indicating the distribution power connect state;
determine if the measured current on a current measurement input among the one or more current measurement inputs of the power distribution circuit exceeds a predefined threshold current level when the distribution switch circuit is closed to couple the distribution power input to the distribution power output; and
in response to the measured current of the power distribution circuit exceeding the predefined threshold current level:
communicate the distribution power connection control signal indicating the distribution power connection mode to the distribution switch control input of the power distribution circuit indicating the distribution power disconnect state; and
communicate the line discharge signal in the closed state to cause the line discharge switch to be closed to discharge the power conductor.

2. The power distribution system of claim 1, wherein:
the one or more power distribution circuits each further comprise:
a distribution management communications output coupled to a management communications link coupled to the assigned remote unit among the plurality of remote units; and
the controller circuit is further configured to, for a power distribution circuit among the one or more power distribution circuits:
communicate a remote power connection signal comprising a remote power connection mode indicating a remote power disconnect state over the distribution management communications output coupled to the assigned remote unit to the power distribution circuit to cause the assigned remote unit to decouple current from the power conductor of the power distribution circuit.

3. The power distribution system of claim 1, wherein in response to the measured current of the power distribution circuit not exceeding the predefined threshold current level, the controller circuit is configured to:
communicate the distribution power connection control signal comprising the distribution power connection mode to the distribution switch control input of the power distribution circuit indicating the distribution power connect state.

4. The power distribution system of claim 3, wherein in response to the measured current of the power distribution circuit not exceeding the predefined threshold current level, the controller circuit is further configured to:
communicate the line discharge signal in the open state to cause the line discharge switch to be opened.

5. The power distribution system of claim 1, wherein:
the controller circuit is further configured to receive a current signal indicating a current level flowing through the line discharge switch;
and in response to the measured current of the power distribution circuit not exceeding the predefined threshold current level, the controller circuit is further configured to:
communicate the line discharge signal in the open state to cause the line discharge switch to be opened.

6. The power distribution system of claim 2, wherein the controller circuit is further configured to, for the power distribution circuit among the one or more power distribution circuits:
communicate the remote power connection signal comprising the remote power connection mode indicating the remote power disconnect state over the distribution management communications output before determining if the measured current on a current measurement input among the one or more current measurement inputs of the power distribution circuit exceeds the predefined threshold current level.

7. The power distribution system of claim 2, wherein the controller circuit is further configured to, for the power distribution circuit among the one or more power distribution circuits:
communicate the remote power connection signal comprising the remote power connection mode indicating a remote power connect state over the distribution management communications output coupled to the assigned remote unit to the power distribution circuit to cause the assigned remote unit to couple to a power conductor of the power distribution circuit.

8. The power distribution system of claim 7, wherein the controller circuit is configured to, for the power distribution circuit among the one or more power distribution circuits:
communicate the remote power connection signal comprising the remote power connection mode indicating the remote power connect state after a predefined time has elapsed after communicating the remote power connection signal comprising the remote power connection mode indicating the remote power disconnect state; and
communicate the line discharge signal in the open state to cause the line discharge switch to be opened.

9. The power distribution system of claim 7, wherein the controller circuit is configured to, for the power distribution circuit among the one or more power distribution circuits:
communicate the remote power connection signal comprising the remote power connection mode indicating the remote power connect state before communicating the remote power connection signal comprising the remote power connection mode indicating the remote power disconnect state.

10. The power distribution system of claim 8, wherein the controller circuit is configured to, for the power distribution circuit among the one or more power distribution circuits, repeatedly:
communicate the remote power connection signal comprising the remote power connection mode indicating the remote power disconnect state over the distribution management communications output; and
communicate the remote power connection signal comprising the remote power connection mode indicating the remote power connect state over the distribution management communications output after the predefined time has elapsed after communicating the remote power connection signal comprising the remote power connection mode indicating the remote power disconnect state.

11. The power distribution system of claim 1, wherein for each power distribution circuit among the one or more power distribution circuits:
the distribution power output comprises the distribution management communications output; and
further comprising a multiplexing circuit coupled between the distribution switch circuit and the distribution power output;
the multiplexing circuit configured to multiplex the distribution power connection control signal and the remote power connection signal over the distribution power output to the assigned remote unit.

12. The power distribution system of claim 2, wherein for each power distribution circuit among the one or more power distribution circuits:
the distribution power output comprises the distribution management communications output; and
further comprising a combining circuit coupled between the distribution switch circuit and the distribution power output;
the combining circuit configured to combine the distribution power connection control signal and the remote power connection signal over the distribution power output to the assigned remote unit.

13. The power distribution system of claim 1, wherein the predefined threshold current level is less than 200 milliAmps (mA).

14. The power distribution system of claim 1, wherein the predefined threshold current level is less than 100 milliAmps (mA).

15. The power distribution system of claim 1, further comprising a housing containing the controller circuit, the current measurement circuit, and the power source.

16. The power distribution system of claim 15, wherein the controller circuit is further configured to:
lower a voltage level on the distribution power output from a first voltage level to second voltage level distributing the received current over the power conductor coupled to the assigned remote unit;
raise the voltage level on the distribution power output from the second voltage level to the first voltage level distributing the received current over the power conductor coupled to the assigned remote unit;
determine if the measured current on the current measurement input among the one or more current measurement inputs of the power distribution circuit exceeds the predefined threshold current level when the distribution switch circuit is closed to couple the distribution power input to the distribution power output in response to the raising of the voltage level on the distribution power output.

17. A method of disconnecting current from a power source, comprising:
decoupling current from a power conductor to a remote unit;
measuring a current received from a power source coupled to the power conductor;
determining if the measured current exceeds a predefined threshold current level; and
in response to the measured current exceeding the predefined threshold current level:
communicating a distribution power connection control signal comprising a distribution power connection mode indicating a distribution power disconnect state to cause the power conductor to be decoupled from the power source; and
communicating a line discharge signal in a closed state to cause a line discharge switch coupled to the power conductor to be closed to discharge the power conductor through the line discharge switch.

18. The method of claim 17, further comprising, in response to the measured current of a power distribution circuit not exceeding the predefined threshold current level:
communicating the distribution power connection control signal indicating the distribution power connect state to cause the power distribution circuit to couple to the power source.

19. The method of claim 18, further comprising, in response to the measured current of a power distribution circuit not exceeding the predefined threshold current level:
communicating the line discharge signal in an open state to cause the line discharge switch coupled to the power conductor to be opened to not discharge the power conductor through the line discharge switch.

20. The method of claim 17, further comprising:
receiving a current signal indicating a current level flowing through the line discharge switch; and
in response to the measured current of the power distribution circuit not exceeding the predefined threshold current level, communicating the line discharge signal in the open state to cause the line discharge switch to be opened.

21. The method of claim 17, wherein decoupling current from the power conductor to the remote unit comprises communicating a remote power connection signal comprising a remote power connection mode indicating a remote power disconnect state over a distribution management communications output coupled to a remote unit among a plurality of remote units, to cause the remote unit to decouple current from the power conductor carrying current to the remote unit.

22. The method of claim 21, further comprising communicating the remote power connection signal indicating the remote power disconnect state before determining if the measured current exceeds the predefined threshold current level.

23. The method of claim 21, further comprising communicating the remote power connection signal indicating a remote power connect state to the assigned remote unit to a power distribution circuit to cause the assigned remote unit to couple current from the power conductor.

24. The method of claim 23, comprising communicating the remote power connection signal indicating the remote power connect state after a predefined time has elapsed after communicating the remote power connection signal indicating the remote power disconnect state.

25. The method of claim 23, comprising communicating the remote power connection signal indicating the remote power connect state before communicating the remote power connection signal indicating the remote power disconnect state.

26. The method of claim 24, comprising repeatedly:
communicating the remote power connection signal indicating the remote power disconnect state to cause the remote unit to decouple current from the power conductor carrying current to the remote unit; and
communicating the remote power connection signal indicating the remote power connect state after the predefined time has elapsed after communicating the remote power connection signal indicating the remote power disconnect state.

27. The method of claim 17, further comprising multiplexing the distribution power connection control signal and the remote power connection signal to the assigned remote unit.

28. The method of claim 17, further comprising combining the distribution power connection control signal and the remote power connection signal to the assigned remote unit.

29. The method of claim 17, further comprising:
lowering a voltage level on the power conductor from a first voltage level to a second voltage level; and
raising the voltage level on the power conductor from the second voltage level to the first voltage level;
wherein:
measuring the current comprises measuring the current received from the power source coupled to the power conductor after the raising of the voltage level on the power conductor.

30-35. (canceled)
